(19) United States
(12) Patent Application Publication
(10) Pub. No.: US 2026/0051270 A1
(43) Pub. Date: Feb. 19, 2026

(54) ENVIRONMENT-RESPONSIVE CONTROL AND PROJECTION OF IMAGES FOR VEHICLES

(71) Applicant: Adeia Guides Inc., San Jose, CA (US)

(72) Inventors: Jean-Yves Couleaud, Mission Viejo, CA (US); Ning Xu, Irvine, CA (US); Reda Harb, Tampa, FL (US)

(21) Appl. No.: 18/802,849

(22) Filed: Aug. 13, 2024

(51) Int. Cl. G09G 3/00; G06F 3/01; G07C 5/02

(52) U.S. Cl. CPC G09G 3/001; G06F 3/011; G07C 5/02; G09G 2354/00; G09G 2380/10

(57) ABSTRACT

Environment-responsive control and projection of images in vehicles are provided. A vehicle's megapixel projector, such as DLP headlights, are controlled using sensor data. Data collection, processing, image generation, user interaction, image adjustment, optimal projection, image customization, ride service verification, environmental condition adjustment, and projector type adjustment are provided. Interaction with a mobile application is provided, allowing users to control a projected image. An image is adjusted based on local conditions detected through an environmental scan and a driver's condition. An optimal location for image projection is determined based on illumination conditions around a vehicle. An image is customized based on various factors and used for ride service verification. An image is adjusted based on a vehicle's location and associated environmental conditions. A DLP projector for a vehicle's headlights enhances quality and versatility of a projected image.

### FIELD OF THE DISCLOSURE

The present disclosure relates to the automotive industry, content delivery, content processing, and content rendering.

### SUMMARY

In ridesharing, incidents of passengers getting into the wrong vehicle are not common, but they do occur. Ride-sharing companies have safety features and provide driver details in their apps to prevent such incidents. Passengers are advised to verify the vehicle and driver information before entering the vehicle. However, despite safety measures, there is still a risk of passengers getting into the wrong vehicle, especially in crowded areas or at night. This could lead to potential safety issues. This “wrong pickup” error results in a bad experience for the rider and the driver but also for another driver who was supposed to pick up the rider, and one or more other riders the driver was supposed to pick up. Anecdotal reports place the rate of wrong pickup at about 2%.

One ride-sharing company offers a dashboard-mounted device (e.g., a beacon) that displays messages to riders and uses color-matching technology to make pickups easier.

However, while the device enhances the pickup experience, it relies on the passenger's ability to identify colors accurately, which might be challenging, for example, for color-blind individuals. Also, its effectiveness might be reduced in bright daylight or when the beacon is obscured.

Also, the use of a digital light processing (DLP) chip in headlights has led to high-resolution headlights that expand the field of view and improve visibility. This technology enables glare-free high beams and symbol projection for hazard warnings, and it enhances advanced driver-assistance systems (ADAS). However, robust integration of DLP headlights with vehicles in real-world conditions is still under development.

Advertising is provided by companies that position displays on car, in car, and use other experiential solutions. In one approach, GPS-enabled triggers allow location-based content delivery. Also, measurement tools are provided for ad effectiveness. However, the use of GPS-enabled triggers for location-based content delivery raises privacy concerns. Further, the effectiveness of the ads depends on the accuracy of the GPS and the relevance of the content to the local audience.

Car rooftop carriers, such as those used for the aforementioned on-car advertising, significantly negatively affect fuel economy. It is generally recommended to remove the roof rack and carrier when not in use to avoid unnecessary impact on fuel economy. Besides affecting fuel economy, rooftop carriers can also impact vehicle dynamics and stability due to the change in the center of gravity. They also increase wind noise and limit access to low-clearance areas.

In various approaches, systems are provided for autonomous vehicles to recognize and approach the correct passenger using gesture recognition, photographs, sensor data, and facial recognition. These technologies aim to improve the efficiency, safety, convenience, and accessibility of passenger pickup services. However, these systems rely on sophisticated sensors and algorithms that might fail under certain conditions (e.g., poor lighting, obscured faces, and the like). Privacy concerns might arise from the use of facial recognition and other personal data. Also, these systems only allow the vehicle to recognize a rider; the rider does not have an automated way to verify the vehicle.

To help address the limitations and problems of these and other approaches, systems and methods are provided for environment-responsive control and projection of images in vehicles. For example, a web-based application is provided to selectively control one or more images for a vehicle equipped with DLP headlights for displaying the one or more images.

In some embodiments, a method is provided for controlling a projector of a vehicle using sensor data. Further, for example, the method includes at least one of data collection, data processing, image generation, user interaction, image adjustment, optimal projection, image customization, ride service verification, environmental condition adjustment, projector type adjustment, web service processing, combinations of the same, or the like.

In some embodiments, data collection and data processing are provided. For example, a vehicle collects environmental data using sensors and sends this data to a web service for processing. The web service then sends back an image data structure and a control data structure, both based on the environmental data.

In some embodiments, image generation is provided. For example, a vehicle sends image data and control data to a megapixel projector controller. The controller then generates an image based on this data.

In some embodiments, a system interacts with a mobile application, providing a user device with options to control an image generated by a projector. Also, for example, the user, via the device, is prompted to choose to associate the image with a vehicle's location.

In some embodiments, image adjustment is provided. For example, a system adjusts an image based on local conditions near a vehicle. The local conditions are detected through an environmental scan. Adjustments include adjusting the image based on a driver's condition, such as drowsiness or distraction.

In some embodiments, optimal projection is provided. For example, a system determines an optimal location for projecting an image based on an illumination condition around a vehicle. Also, for example, a surface is detected for projection, a location on the surface is identified, and a distance and relative orientation from the surface to the vehicle is determined. The image is adjusted based on the detected surface, the identified location, the determined distance, and the relative orientation.

In some embodiments, image customization is provided. For example, an image is customized based on one or more factors. Also, for example, the image is adjusted for brightness, color, and direction to ensure the image is scannable by an external mobile device.

Further, for example, the image is selected based on a user profile and includes identification of a hazard, a direction cue, or both.

In some embodiments, ride service verification is provided. For example, an image is provided for verifying a ride service, such as a robotaxi service. A system receives a signal from a rider's mobile device verifying capture of the image. Upon verification, the vehicle is unlocked.

In some embodiments, environmental condition adjustment is provided. For example, a system determines a vehicle's location, sends the vehicle's location to a web service, and receives an environmental condition associated with the location. An image is then generated based on the environmental condition. The environmental condition includes, for example, a weather condition.

In some embodiments, projector type adjustment is provided. For example, a megapixel projector includes a DLP projector for one or more headlights of a vehicle.

In some embodiments, web service processing is provided. For example, the web service receives an environmental scan, sends environmental metadata to a DLP controller (e.g., a virtual DLP controller), receives DLP control information, sends image generation instructions to an image generator, and receives an image based on these instructions. The web service then sends an image data structure and a megapixel projector control data structure to a vehicle, enabling generation of the image by a megapixel projector.

In some embodiments, a method for validating a ride service using a vehicle's megapixel projector is provided. For example, the method includes at least one of ride requesting, ride confirming, validation image projecting, image scanning, vehicle unlocking, image directing, combinations of the same, or the like. Also, for example, for ride request and ride confirmation, a user, via a device, is prompted to send a ride request from a ride application installed on the device to a server of a ride service. The application then receives a confirmation of the ride from a vehicle associated with the ride service. Further, for example, validation image projecting is provided. When a vehicle arrives at a pickup location, the vehicle's megapixel projector projects a validation image. This image is unique to the ride and is made available to the ride application on the user's device. In addition, image scanning and vehicle unlocking are provided. The ride application receives a signal indicating that the user's device has scanned the validation image.

Upon receiving this signal, the vehicle is unlocked. Moreover, for example, image directing is provided. A validation image is directed towards a location of an external user's device or towards a particular point of interest.

As a result of the one or more embodiments presented herein, one or more technical improvements are achieved. For example, a system's ability to interact with a mobile application provides control of an image generated by a projector. Also, for example, by monitoring a condition of a driver, such as drowsiness or distraction, a system makes necessary adjustments to a projected image, preventing accidents. Further, for example, efficient ride service verification is provided. A unique validation image projected by a vehicle for ride service verification provides a quick and efficient way to confirm a ride, enhancing security and convenience of the service. In addition, for example, a system's ability to determine an optimal location for image projection based on various factors, such as an illumination condition around a vehicle and a flatness of a surface for projection, ensures the image is clear and visible. Moreover, for example, a system adjusts an image based on a vehicle's location and associated environmental conditions, such as weather, making the system adaptable to different situations. Furthermore, for example, an ability to select an image for projection based on a user profile improves recognition by a user and improves security. Additionally, for example, the use of a DLP projector for a vehicle's headlights improves a quality and versatility of a projected image. Still further, for example, use of environmental scans and local conditions to adjust an image projected by a vehicle improves road safety. The image includes identification of a hazard and a direction cue that avoids the hazard.

Related systems, devices, non-transitory, computer-readable media, and the like are also provided.

The present invention is not limited to the combination of the elements as listed herein and may be assembled in any combination of the elements as described herein. These and other capabilities of the disclosed subject matter will be more fully understood after a review of the following figures, detailed description, and claims.

### BRIEF DESCRIPTIONS OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration these drawings are not necessarily made to scale.

The embodiments herein may be better understood by referring to the following description in conjunction with the accompanying drawings, in which like reference numerals indicate identically or functionally similar elements, of which:

FIG. 1 depicts an example system including a vehicle, data acquisition, cloud-based processing, a DLP headlight, and an image for display, in accordance with some embodiments of the disclosure;

FIG. 2 depicts an example system for implementation of a DLP headlights subsystem accessed by an external cloud-based system over a wireless network, in accordance with some embodiments of the disclosure;

FIG. 3 depicts an example process for system exchanges for automated ride validation, in accordance with some embodiments of the disclosure;

FIG. 4 depicts an example autonomous vehicle with DLP headlights displaying one or more symbols in front of the vehicle, in accordance with some embodiments of the disclosure;

FIG. 5 depicts an example augmented reality (AR) device for identifying a ride sharing vehicle, in accordance with some embodiments of the disclosure;

FIG. 6 depicts an example process for controlling a megapixel projector of a vehicle including a sensor, in accordance with some embodiments of the disclosure;

FIG. 7 depicts an example process for controlling a megapixel projector of a vehicle including a sensor, in accordance with some embodiments of the disclosure;

FIG. 8 depicts an example process for controlling a megapixel projector of a vehicle including a sensor, in accordance with some embodiments of the disclosure;

FIG. 9 depicts an example process for controlling a megapixel projector of a vehicle including a sensor, in accordance with some embodiments of the disclosure;

FIG. 10 depicts an example process for controlling a megapixel projector of a vehicle including a sensor, in accordance with some embodiments of the disclosure;

FIG. 11 depicts an example process for controlling a megapixel projector of a vehicle including a sensor, in accordance with some embodiments of the disclosure;

FIG. 12 depicts an example process for controlling a megapixel projector of a vehicle including a sensor, in accordance with some embodiments of the disclosure;

FIG. 13 depicts an example process for controlling a megapixel projector of a vehicle including a sensor, in accordance with some embodiments of the disclosure;

FIG. 14 depicts an example process for controlling a megapixel projector of a vehicle including a sensor, in accordance with some embodiments of the disclosure;

FIG. 15 depicts an example process for controlling a megapixel projector of a vehicle including a sensor, in accordance with some embodiments of the disclosure;

FIG. 16 depicts an example process for controlling a megapixel projector of a vehicle including a sensor, in accordance with some embodiments of the disclosure;

FIG. 17 depicts an example process for controlling a megapixel projector of a vehicle including a sensor, in accordance with some embodiments of the disclosure;

FIG. 18 depicts an example process for controlling a megapixel projector of a vehicle including a sensor, in accordance with some embodiments of the disclosure;

FIG. 19 depicts an example process for controlling a megapixel projector of a vehicle including a sensor, in accordance with some embodiments of the disclosure;

FIG. 20 depicts an example process for controlling a megapixel projector of a vehicle including a sensor, in accordance with some embodiments of the disclosure;

FIG. 21 depicts an example of an artificial intelligence system, in accordance with some embodiments of the disclosure; and

FIG. 22 depicts an example of a communication system including a server, a communication network, and a computing device for performing the methods and processes, in accordance with some embodiments of the disclosure.

The drawings are intended to depict only typical aspects of the subject matter disclosed herein, and therefore should not be considered as limiting the scope of the disclosure. Those skilled in the art will understand that the structures, systems, devices, and methods specifically described herein and illustrated in the accompanying drawings are non-limiting exemplary embodiments and that the scope of the present invention is defined solely by the claims.

### DETAILED DESCRIPTION

A vehicle is equipped with improved light emitting devices (e.g., headlights) that display and adjust images based on various factors. For example, when driving on a foggy night, the vehicle collects data about the foggy environment using sensors and sends this data to a web service. The web service processes the data and sends back instructions to the vehicle about what image to display and how to control the headlights. The vehicle then uses these instructions to generate an image that helps a driver navigate through the fog. For instance, the image could be a direction cue that guides a driver safely on the road. Further, the vehicle detects whether the driver is drowsy and adjusts the image accordingly to keep the driver alert and prevent accidents. Still further, for example, one or more vehicle sensors send signals (e.g., images) to a web server for analysis and determination of whether the driver is, for example, drowsy, which triggers an image adjustment and/or other suitable alerts.

The vehicle interacts with a mobile application on a smartphone. This app gives the smartphone user options to control the image displayed by the headlights. For example, the smartphone user can choose to associate the image with the vehicle's location. Also, for example, based on detection of a particular location of the vehicle (e.g., parked at home), an image associated with the vehicle's location is displayed.

A system customizes the image based on various factors. For instance, the system adjusts the image's brightness, color, and direction to ensure visibility and usefulness. The system selects an image based on a user profile, such as an image that identifies a hazard or provides a direction cue.

As semiautonomous and autonomous vehicles enter the marketplace, the image projection and interaction improve a ride from a robotaxi service. Initially, a captured image may be matched with a known image. When the robotaxi arrives at a user's location, the robotaxi projects a unique image for verifying the ride. Once the would-be rider captures this image with a smartphone, the robotaxi receives a signal and unlocks the vehicle for the rider. For example, if the image does not match, a device displays a notification indicating the mismatch. Also, for example, the scanned robotaxi informs the user's device of its current location. Further, for example, the robotaxi communicates with a correct robotaxi to relay the user's location via their device. In addition, for example, even if the wrong image gets scanned, the rideshare app identifies which robotaxi is being scanned and obtains the scanner's ride information. As such, the user, via their device, is always informed about their ride status.

The system adjusts the image based on the vehicle's location and the associated environmental conditions, such as weather. For instance, if it is raining, the system generates an image that assists safe navigation in the rain.

In some embodiments, a system is provided that uses DLP projectors in a vehicle's headlights to improve road safety, enhance the convenience of ride services, and adapt to different situations. Images are projected that are responsive to the environment and customizable based on various factors. This system represents a significant advancement in vehicle technology. Although some examples are provided with respect to one or more megapixel projectors and/or one or more DLP projectors, it is understood that, in some embodiments, one or more projectors include at least one of a megapixel projector, a 4K laser projector, a short-throw projector, a holographic projector, a 3D projector, a light-emitting diode (LED) light, combinations of the same, or the like.

High-resolution DLP headlights are an advanced automotive lighting technology that enhance safety and visibility. For example, DLP headlights are provided including an arrangement of individually controlled digital micromirrors (e.g., a 0.55-inch diagonal digital micromirror device), much like pixels in a digital projector. Also, for example, the DLP headlights are configured for precise manipulation and projection of light patterns, e.g., on a surface of road (e.g., at a distance of about three meters in front of the vehicle and/or at a distance dynamically adjusted based on a speed of the vehicle). Further, for example, DLP headlights produce detailed and accurate light distributions, which adapt dynamically to a driving environment. In addition, for example, beams of headlights are controlled to prevent a “dazzling” or blinding effect on other drivers. Moreover, for example, beams of headlights are controlled to maximize a visibility of features adjacent a vehicle from a perspective of a driver of the vehicle.

In some embodiments, high-resolution DLP headlights project one or more specific patterns of light. For example, the patterns of light provide at least one of spotlighting a road sign, spotlighting a potential hazard, projecting a symbol directly onto a surface of a road, projecting a symbol to communicate with a driver and/or a pedestrian about a condition (e.g., ice), projecting a symbol to communicate with a driver and/or a pedestrian to provide a directional cue, combinations of the same, or the like.

In some embodiments, in combination with features and embodiments described herein, a multiple pixel arrangement (e.g., an 84-pixel LED matrix) is provided. For example, a DLP headlight is provided with a multiple pixel arrangement. Also, for example, a high resolution DLP for adaptive driving beam (ADB) headlights is provided, having at least about 1.3 million pixels per headlight.

In some embodiments, in combination with features and embodiments described herein, DLP headlights are provided to display information to at least one of a driver, a passenger, a robotaxi rider, combinations of the same, or the like.

In some embodiments, systems and methods are provided with a web-based application configured to selectively control one or more images for a vehicle equipped with DLP headlights for display of the one or more images on a surface.

In some embodiments, a headlight is provided for displaying one or more symbols on a surface (e.g., a surface of a road or rough ground). For example, methods for generating one or more symbols are provided with instructions for focusing a DLP headlight on a surface taking into consideration various factors including at least one of a distance to the surface, a roughness of the surface, a location of a mobile device (of a user) relative to the vehicle, a distance between a mobile device (of a user) to the vehicle, a weather condition, a lighting condition, a brightness of the DLP headlight, combinations of the same, or the like. Also, for example, at least one of a brightness, a color, or a direction for projection of the image is adjusted to ensure a projected image is scannable by a mobile communication device external to the vehicle. In addition, for example, at least one of a brightness, a color, or a direction for projection of the image is based on an estimated location of a mobile device, and adjusted to ensure a projected image is scannable by the mobile device external to the vehicle. Moreover, for example, a source of an image for one or more DLP headlights is provided. Furthermore, for example, a source of an image for one or more DLP headlights utilizes upward logic to generate the image. In addition, for example, artificial intelligence (AI) image generation is provided. Additionally, for example, computer-generated imagery (CGI) is provided. Furthermore, for example, three-dimensional (3D) rendering is provided. Still further, for example, for generating one or more images, AI models are configured to render an image based at least in part on at least one factor including a subject of the image, a physical description of the image, one or more colors for the image, one or more materials of a depicted object for the image, combinations of the same, or the like.

In some embodiments, an exchange mechanism is provided between a vehicle headlight controller and one or more web services. For example, an environmental scan includes at least one of an interior of a vehicle, an exterior of the vehicle, an object inside the vehicle, combinations of the same, or the like. Also, for example, an environmental scan is performed by a vehicle and sent by the vehicle to a web service provider. Further, for example, an environmental scan informs the generation of a symbol and/or an image for output by a headlight of a vehicle. In addition, for example, metadata is provided for instructing a headlight controller on a modality of a reproduction of an image.

In some embodiments, vehicle original equipment manufacturers provide improved headlights with a vehicle. For example, the improved headlights are configured for one or more applications. Also, for example, semiautonomous and autonomous vehicle fleet operators and rideshare providers (e.g., Uber and Lyft) specify improved headlights with a vehicle for the fleet. Further, for example, systems and methods for identifying and unlocking semiautonomous and autonomous vehicles are provided.

In some embodiments, a system and a related method provide a comprehensive approach to vehicle safety and convenience by integrating various sensors and technologies. The system includes both interior and exterior sensors to monitor the vehicle's surroundings and occupants, enhancing functions such as adaptive cruise control, collision avoidance, and parking assistance. The system leverages cloud-based processing and connectivity with smartphones to dynamically manage and utilize data, ensuring real-time responsiveness and improved user experience.

Additionally, the integration of a DLP headlight system allows for advanced image projection, further augmenting the vehicle's capabilities.

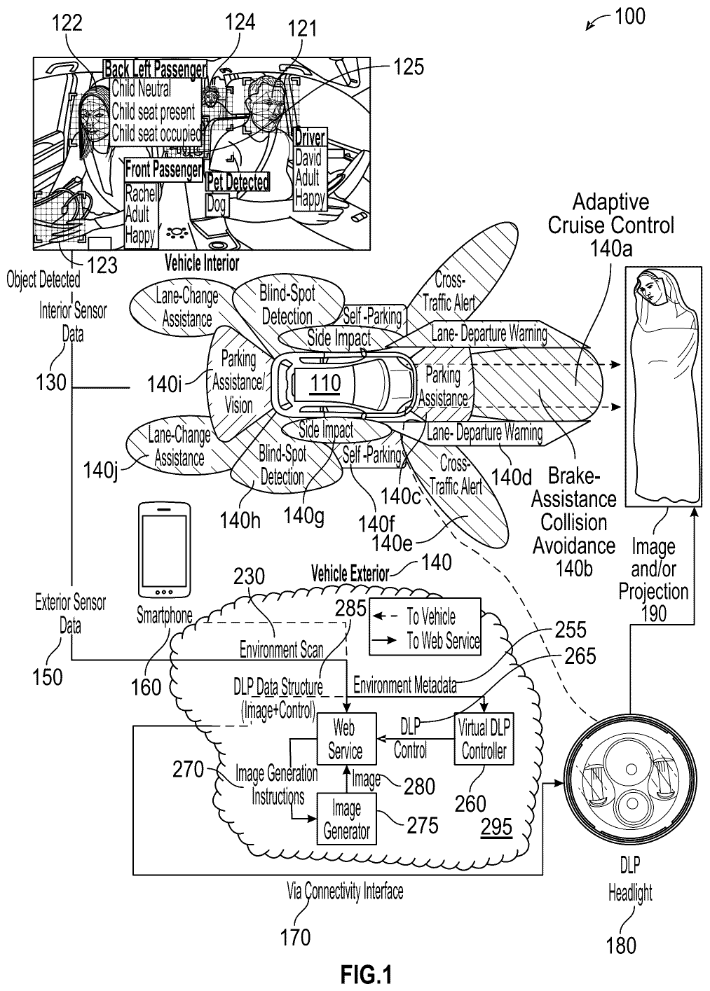

FIG. 1 depicts an example system 100 including at least one of a vehicle 110, a vehicle interior 120, acquisition of interior sensor data 130 regarding objects in the vehicle interior 120, a vehicle exterior 140, acquisition of exterior sensor data 150 supporting various functions occurring at or near the vehicle exterior 140, a smartphone 160, a cloud-based system 295 for processing data and generating a DLP data structure 285, a connectivity interface 170, a DLP headlight 180, or an image and/or projection 190 generated by the DLP headlight 180, in accordance with some embodiments of the disclosure. Although the vehicle 110 is illustrated as a passenger vehicle, any suitable vehicle may be provided such as, for example, a sedan, a crossover, a sport utility vehicle, a hatchback, a motorcycle, a bicycle, a scooter, a truck, a drone, a boat, an aerial vehicle, a bus, or the like.

In this example, the vehicle interior 120 of the vehicle 110 is occupied by at least a driver 121, a front passenger 122, a first object 123 near the front passenger 122, a back left passenger 124, and a second object 125 near the back left passenger 124. Also, for example, the system 100 is configured to identify, based, e.g., on a user profile and/or metadata, objects, e.g., the driver 121 is “David,” and the front passenger 122 is “Rachel.” Further, for example, the system 100 is configured to identify, based, e.g., on facial recognition and/or object recognition, that David is an adult and is expressing a happy appearance, that Rachel is an adult and is expressing a happy appearance, that the first object 123 near the front passenger 122 is a purse, that the back left passenger 124 is a child, that a child seat is present, that the child seat is occupied, and that the second object 125 near the back left passenger 124 is a dog. In addition, for example, the interior sensor data 130 includes some or all of the data described above or the like.

Also, in this example, the vehicle 110 is configured with one or more functions 140a-140j. For example, the one or more functions 140a-140j include one or more radar applications and/or one or more ultrasonic functions. Also, for example, the one or more radar applications include at least one of adaptive cruise control 140a, brake-assistance and/or collision avoidance 140b, cross-traffic alert 140e, side impact 140g, blind-spot detection 140h, lane-change assistance 140j, combinations of the same, or the like. Further, for example, the one or more ultrasonic functions include at least one of parking assistance 140c, self-parking 140f, parking assistance and/or vision 140i, combinations of the same, or the like. In addition, for example, some functions, such as lane-departure warning 140d utilize multiple technologies including, for example, at least one of a video sensor, a laser sensor, an infrared sensor, combinations of the same, or the like. Moreover, for example, the exterior sensor data 150 includes some or all of the data from one or more of the functions described above or the like. Any of these functions may be provided for one or more portions of the vehicle including at least one of a front portion, a rear portion, a left (or driver's side in the U.S.) portion, a right (or passenger's side in the US) portion, an above portion, a below portion, combinations of the same, or the like.

Further, for example, a smartphone 160 is configured to send and/or receive data to the cloud-based system 295. Details of data provided by or to the smartphone 160 or the like are provided herein.

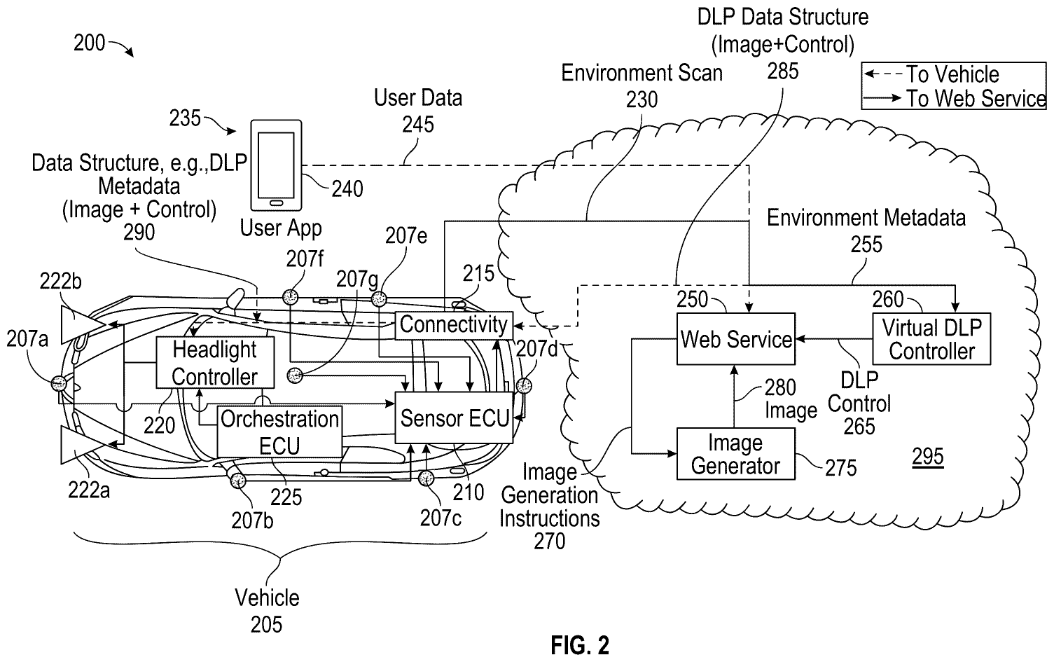

In addition, for example, details of the cloud-based system 295 are provided herein with reference, for example, to the embodiment of FIG. 2.

Moreover, for example, the cloud-based system 295 is connected to the DLP headlight 180 via the connectivity interface 170. Details of the connectivity interface 170 or the like are provided herein with reference, for example, to the embodiment of FIG. 2.

Furthermore, for example, the DLP headlight 180 is configured to generate the image 190. For example, the image 190 is generated based at least in part on at least one of one or more portions of the interior sensor data 130, one or more portions of the exterior sensor data 150, data from the smartphone 160, instructions from the cloud-based system 295, combinations of the same, or the like. Details of the generation of the image 190 or the like are provided herein with reference, for example, to the embodiment of FIG. 2.

In some embodiments, the system 100 is provided for at least one of public transportation, delivery drones, autonomous taxi services, emergency vehicles, military vehicles, personal cars, rental cars, bicycles, or the like. For example, in a bus or train scenario, the system identifies and tracks all passengers, their belongings, and their interactions. This enhances safety by identifying suspicious behavior or objects and improves service by understanding passenger needs better. Also, for example, for delivery drones, the exterior sensor data is used to navigate the drone, while the interior sensor data monitors the package being delivered. The cloud-based system processes this data to optimize delivery routes and ensure package safety. Further, for example, for autonomous taxi services, the system identifies the passenger, their mood, and any accompanying objects (like luggage). This personalizes the ride experience, for example, by adjusting the car's environment based on the passenger's preferences or mood. In addition, for example, for emergency vehicles, such as an ambulance, the system monitors the patient's condition in real time and relays this data to the hospital. The exterior sensors help navigate traffic more efficiently. In addition, for example, in a military vehicle like a tank or a fighter jet, the system monitors the status of the vehicle, the soldiers, and their equipment. The exterior sensors provide data about the surroundings, helping with navigation and threat detection.

Moreover, for example, in personal vehicles, the system provides a more personalized and safer driving experience. It identifies the driver and adjusts settings according to their profile (e.g., seat position, music preferences, etc.). The system identifies if the driver is tired or distracted and issues alerts. Furthermore, for example, for rental cars, the system identifies the driver and automatically adjusts the vehicle settings to their preferences. It monitors the vehicle's condition and usage, providing valuable data to the rental company. Additionally, for example, in a bicycle, the system monitors the cyclist's health data (such as heart rate) and the bicycle's condition. The exterior sensors help navigate and alert the cyclist about potential hazards.

Turning to detailed descriptions, as provided in detail herein, a system includes a vehicle and integrated and/or external control systems. For example, the vehicle is equipped with DLP headlights that project one or more symbols and/or images onto various surfaces. Also, for example, a headlight controller receives a data structure containing an image and projection instructions, which allow the headlight controller to control the DLP headlight to display a symbol and/or an image on a particular surface. Further, for example, the system adjusts brightness, colors, and direction of a projection of the symbol and/or the image to ensure readability under different conditions. In addition, for example, the vehicle communicates environmental awareness to a web service, which uses this information to generate DLP instructions. Moreover, for example, the web service processes one or more symbols and/or images to be projected to compensate for an existing appearance of a surface (e.g., a color, shading, and shadow of the surface), ensuring that the projected symbol and/or image is visible. Furthermore, for example, the web service uses information from a user device to generate both the image and/or the symbol to be projected and the projection instructions. Additionally, for example, a vehicle owner can store one or more images on their mobile device that they want to display when, for example, reaching certain destinations. Still further, for example, the stored image is transmitted to the web service to generate instructions for the headlight controller to generate an equivalent image via the DLP headlight.

In some embodiments, a vehicle is provided with a light emitting device, e.g., a set of DLP headlights, to project symbols on various surfaces ahead of the vehicle. FIG. 2 depicts an example system 200 including a vehicle 205 for implementation of a DLP headlights subsystem 222a, 222b accessed by an external cloud-based system 295 over a wireless network, in accordance with some embodiments of the disclosure. Although the vehicle 205 is illustrated as a passenger vehicle, any suitable vehicle may be provided such as, for example, a sedan, a crossover, a sport utility vehicle, a hatchback, a motorcycle, a bicycle, a scooter, a truck, a drone, a boat, an aerial vehicle, a bus, or the like. For example, a headlight controller 220 receives a data structure 290. Also, for example, the data structure 290 includes at least one of DLP metadata, image instructions, control instructions, combinations of the same, or the like. Further, for example, the data structure 290 includes an image and a set of projection instructions allowing the headlight controller 220 to control the DLP headlight 222a, 222b to display a specific symbol matching the image on a particular surface. In addition, for example, the projection instructions include elements such as colors, brightness to control an overall appearance of a symbol, and supplemental instructions regarding a location of a projection. Moreover, for example, the data structure 290 includes instructions to project an image only when the vehicle 205 is stopped. Furthermore, for example, the data structure 290 includes instructions to project an image only on a vertical wall within a certain distance from the vehicle 205. Additionally, for example, to generate a readable symbol or plurality of symbols in many conditions, a component of the system 200 adjusts a brightness, one or more colors, and a direction of a projection of the one or more symbols. Still further, for example, a component of the system 200 inverts a black-and-white image between night and day, using white to display a complement of a symbol and/or unlit areas for the symbol itself at night; whereas a component of the system 200 uses white (or any other suitable color) to generate the symbol during the day, or any other suitable combination to achieve a viewable symbol. Even further, a component of system 200 adjusts a color used to display one or more symbols beyond black-and-white. Yet further, a component of system 200 is instructed to display one or more symbols in a shaded area, such as in a shadow of the vehicle 205, when, for example, bright sunlight is sensed or detected, or information indicating a sunny weather condition is received.

In some embodiments, display of one or more symbols and/or images is provided for two or more vehicles in close proximity, where each of the vehicles is projecting one or more symbols and/or images (see, for example, the robotaxi examples described herein). For example, a data structure 290 includes instructions for the ADAS of a first autonomous vehicle to command the first autonomous vehicle to park close to a second vehicle displaying a rider symbol of the second vehicle without overlapping the rider symbol of the second vehicle, and far enough from the second vehicle so that the first autonomous vehicle has enough room to display one or more symbols and/or images. Also, for example, the data structure 290 includes scaling instructions, allowing the headlight controller 220 to project one or more symbols and/or images on a wide variety of surfaces while maintaining readability. Further, for example, a component of the system 200 receives an image, a minimum scale of 0.5, and a maximum scale of 2.0. In addition, for example, upon reaching a destination where the vehicle 205 is instructed to display a symbol, the vehicle 205 adapts a scale of the symbol between 0.5 and 2.0 depending on a surface to receive a projection of the symbol. Moreover, for example, a component of the system 200 selects a scaling factor of 0.5 to project a symbol in a relatively tight area between a front of the vehicle 205 and a second vehicle. Furthermore, for example, a component of the system 200 selects a scaling factor of 2.0 to project a symbol on a vertical wall located a relatively large distance away from the vehicle 205. Additionally, for example, a first vehicle is instructed to alter its current image projection to make room for a second vehicle to display their image projection. Still further, for example, a first vehicle is instructed to take an action, such as moving, to accommodate the projection of a second vehicle.

In some embodiments, a component of the system 200 communicates environmental awareness. For example, an environmental scan 230 is transmitted to a web service 250 to provide the web service 250 with information. Also, for example, the information includes a wide variety of sources and/or types of information. Further, for example, the vehicle 205 is equipped with one or more sensors. In addition, for example, the one or more sensors may be internal sensors, external sensors, cameras, combinations of the same, or the like. Moreover, for example, as shown in FIG. 2, the vehicle 205 includes at least one of a forward-facing camera 207a, a lateral-facing camera 207b, a gas tank sensor 207c, a rear-facing camera 207d, an external collision sensor 207e, a door open and/or door close sensor 207f, an internal sensor 207g, combinations of the same, or the like. Furthermore, for example, the one or more sensors include at least one of an engine oil level sensor, an engine oil pressure sensor, a coolant temperature sensor, a mass airflow sensor, an intake air temperature sensor, an air-flow sensor, an engine knock sensor, an engine speed sensor, a crankshaft position sensor, a camshaft position sensor, an oxygen sensor, a manifold absolute pressure sensor, a throttle position sensor, a voltage sensor, one or more position sensors, one or more acceleration sensors, one or more speed and/or velocity sensors, one or more pressure sensors, one or more torque and/or force sensors, one or more light sensors, one or more imaging devices, one or more cameras, one or more radar sensors, one or more light detection and ranging (lidar) sensors, one or more ultrasonic sensors, one or more thermal imaging sensors, a global navigation satellite system, one or more proximity detection sensors, one or more gesture recognition sensors, one or more vehicle-to-vehicle sensors, one or more vehicle-to-infrastructure sensors, one or more vehicle-to-everything sensors, one or more vehicle-to-pedestrian sensors, one or more vehicle-to-network sensors, one or more vehicle-to-cloud sensors, one or more vehicle-to-device sensors, one or more vehicle-to-grid sensors, combinations of the same, or the like.

In some embodiments, sensors, such as cameras, lidar and the like, provide situational awareness to an ADAS of the vehicle 205. For example, data from one or more sensors is collected by one or more electronic control units (ECUs). Also, for example, one or more ECUs communicate one or more portions of the data from the one or more sensors to the web service 250 or a plurality of web services. Further, for example, a sensor ECU 210 sends data from one or more sensors to a connectivity link 215. In addition, for example, the connectivity link 215 is connected to a wide area network (WAN). Moreover, for example, the connectivity link 215 is connected to at least one of a 4G/LTE network, a 5G network, a 6G network, combinations of the same, or the like. Furthermore, for example, the environmental scan 230 is sent to the web service 250. Additionally, for example, the web service 250 may generate a DLP data structure 285 based at least in part on the environmental scan 230. Still further, for example, the DLP data structure 285 is the same as the data structure 290. Even further, for example, the DLP data structure 285 is converted, e.g., at the connectivity link 215, into the data structure 290 into a format suitable for the headlight controller 220. Yet further, for example, the environmental scan 230 includes one or more images and/or one or more lidar scans describing surroundings of the vehicle 205. Further still, for example, the web service 250 communicates with a controller, such as virtual DLP controller 260.

In some embodiments, the web service 250 receives the environment scan 230, converts the environment scan 230 to environment metadata 255, and sends the environment metadata 255 to the virtual DLP controller 260. For example, the virtual DLP controller 260 analyzes one or more images and/or one or more lidar scans. Also, for example, the virtual DLP controller 260 outputs a list of location candidates for display of a particular symbol. Further, for example, the virtual DLP controller 260 receives a symbol request and the environment scan 230, and, based on the symbol request and the environment scan 230, the virtual DLP controller 260 adjusts the symbol to match the environment scan 230 (e.g., scaling when projecting on a tilted surface). In addition, for example, the virtual DLP controller 260 attaches one or more locations for display of a particular symbol as part of DLP control instructions 265 for projection of the particular symbol by one or more DLP headlights 222a, 222b. Moreover, for example, the virtual DLP controller 260 generates DLP control instructions 265 for the headlight controller 220 to instruct one or more DLP headlights 222a, 222b. Furthermore, for example, the virtual DLP controller 260 detects, based at least in part on the environmental scan 230 and/or the environment metadata 255, that the vehicle 205 is in a relatively bright place. Additionally, for example, in response to the detecting, based at least in part on the environmental scan 230 and/or the environment metadata 255, that the vehicle 205 is in the relatively bright place, the virtual DLP controller 260 adds instructions for the headlight controller 220 to maximize a brightness of the DLP headlights 222a, 222b for display of the symbol.

In some embodiments, image generation is based at least in part on the environmental scan 230. For example, the web service 250 receives the environmental scan 230 and sends image generation instructions 270 to an image generator 275 based at least in part on the environmental scan 230. Also, for example, the image generator 275 generates one or more images 280 based at least in part on the image generation instructions 270. Further, for example, the environmental scan 230 indicates that the vehicle 205 is parked in an indoor location, e.g., inside a parking structure. In addition, for example, based at least in part on the environmental scan 230 indicating that the vehicle 205 is parked in the indoor location, the web service 250 generates an image (e.g., a high-detail image) to be projected at the indoor location. Moreover, for example, the environment scan 230 indicates that the vehicle 205 is parked in an outside location, e.g., in direct sunlight. Furthermore, for example, based at least in part on the environment scan 230 indicating that the vehicle 205 is parked in the outside location, e.g., in the direct sunlight, the web service 250 generates an image (e.g., a low-detail image, or an image tuned to bright light levels) to account for a readability of a symbol in direct or indirect sunlight. Additionally, for example, one or more sensors provide at least one of real-time detection of ambient conditions, adaptation of content rendering and display, integration with one or more projectors and/or headlights, adaptation for a distance to a surface of one or more images and/or projections, combinations of the same, or the like.

In some embodiments, one or more environmental scans 230 include data representing at least one of color, shading, shadow, or a pattern of a plane on which an image and/or a symbol is to be displayed. For example, one or more images and/or symbols to be projected are processed to compensate for at least one of the color, the shading, the shadow, or the pattern of the plane so that the one or more images and/or symbols are visible. Also, for example, the web service 250 utilizes sensing data to detect a flatness of a plane to be projected on. Further, for example, the web service 250 generates instructions to project one or more images and/or symbols on a flat part. In addition, for example, the web service 250 modifies one or more images and/or symbols to be projected so that the projected one or more images and/or symbols on a non-flat surface appear flat from a perspective of an intended direction of a viewer of the projected one or more images and/or symbols. Moreover, for example, the web service 250 modifies one or more images and/or symbols to be projected so that the projected one or more images and/or symbols are optimized for a direction of a viewer relative to a surface on which the one or more images and/or symbols are projected. Furthermore, for example, the web service 250 modifies one or more images and/or symbols to have a 3D appearance from a perspective of a viewer.

In some embodiments, the web service 250 utilizes information from a user device 235 to generate one or more images and/or symbols to be projected and/or projection instructions for the same. For example, the information from the user device is part of a user profile stored in the user device 235 and/or in a remote storage (not shown). Also, for example, an owner of the vehicle 205 fitted with smart headlights (e.g., 222a, 222b) stores on a mobile device (e.g., 235) an image that they want to display when reaching one or more destinations. Further, for example, using an application 240 installed on the user device 235, the owner selects options to display a photo of their dog every time they drive into a parking lot of a dog park. In addition, for example, a picture is generated or stored on the user device 235 and transmitted, e.g., as data 245, to the web service 250 to generate an equivalent image for instructing the headlights (e.g., 222a, 222b) to display the equivalent image by the headlight controller 220. That is, for example, an instruction to display an image (e.g., the photo of the dog) when reaching the dog park's parking lot is programmed on the user device 235 and then converted into a set of instructions understandable by the vehicle 205, e.g., by the headlight controller 220.

In some embodiments, an orchestration ECU 225 is provided. For example, the orchestration ECU 225 prevents one or more non-critical commands from gaining priority over one or more critical commands. Also, for example, the web service 250 instructs the vehicle 205 to display a pattern in front of the vehicle 205, such as the image of the dog described herein. Further, for example, upon reaching the dog park, the vehicle 205 detects a pedestrian in a path of the vehicle 205. In addition, for example, in response to the vehicle 205 detecting the pedestrian in the path of the vehicle 205, the orchestration ECU 225 prioritizes one or more safety measures, e.g., the pedestrian is automatically highlighted by the headlights 222a, 222b.

Moreover, for example, the orchestration ECU 225 instructs the headlight controller 220 to stop dedicating one or more resources to the lower priority display, e.g., the dog picture. Furthermore, for example, either alone or in combination with the orchestration ECU 225 instructing the headlight controller 220 to stop dedicating the one or more resources to the lower priority display, the orchestration ECU 225 instructs the one or more resources to perform the one or more safety measures.

In some embodiments, the vehicle 205 captures one or more projected images and/or symbols with one or more sensors, and, based at least in part on the one or more projected images and/or symbols captured by the one or more sensors, the vehicle 205 determines that the one or more projected images and/or symbols overlap, if projected, or will overlap, before projection, with one or more images and/or symbols projected by a neighboring vehicle. For example, upon detecting that a neighboring vehicle's projection occupies a relatively large surface area, the vehicle 205 communicates with the neighboring vehicle or a service connected to the neighboring vehicle to negotiate real estate for the projection. Also, for example, the vehicle 205 and the neighboring vehicle alter their respective environment scans to include information including, e.g., each other's shared projection surface, each other's initial projection constraints, or the like. Further, for example, the vehicle 205 and the neighboring vehicle communicate with their respective web services to request and receive a new set of projection instructions and symbols to display.

In some embodiments, the headlight controller 220 implements a queuing mechanism to manage conflicting display instructions from more than one web service. For example, the vehicle 205 is communicating with more than one web service sharing access to the headlights 222a, 222b. Also, for example, the data structure (e.g., 285, 290) described herein includes a priority tag allowing the headlight controller 220 to clear conflicts. Also, for example, the orchestration ECU 225 decides what service has priority access to one or more headlights 222a, 222b. Further, for example, the headlight controller 225 attempts to combine two or more access requests. In addition, for example, if instructed by a first web service to display image A and by a second web service to display image B with a similar set of projection instructions, the headlight controller 225 merges and/or joins both images into one. Moreover, for example, the headlight controller 220 instructs a left headlight 222a to display image A and a right headlight 222b to display image B.

In some embodiments, the systems and methods disclosed herein provide multiple functions across multiple use cases. For example, the systems and methods disclosed here are configured to display an advertisement for viewing by one or more viewers near a vehicle at a rest stop. Also, for example, the advertisement includes a message such as “2 for 1 hamburgers 20 miles away at Jim's!”

As described in detail herein, various methods to locate and unlock a robotaxi are provided to solve the problem of riders accidentally boarding the wrong vehicle. The methods include using smart headlights to display ride information and unlock codes, fitting vehicles with near field communication (NFC) or Bluetooth locks, displaying machine-readable codes on external screens or active vehicle paint, and using biometric data of the rider. As a result, rider identification and verification are improved, and the “wrong pickup”problem is made less likely.

In some embodiments, a method is provided to locate and/or unlock a robotaxi. The wrong pickup problem described herein is expected to be exacerbated by the deployment of fully autonomous robotaxi fleets. For example, the wrong pickup problem is complicated by factors such as a similar appearance for several vehicles provided by a same robotaxi provider, the potential absence of a license plate, and the lack of a human driver present in the vehicle. For example, a process is provided allowing a rider to quickly verify that they are boarding the right robotaxi prior to actually boarding the robotaxi. Also, for example, smart headlights are provided to display ride information and machine-readable unlock codes so that a rider can enter their programmed vehicle.

In some embodiments, in combination with features and embodiments described herein, a vehicle is equipped with an NFC and/or Bluetooth lock similar to those some hotels provide to reduce the wrong pickup problem. Also, for example, “smart locks” are installed in a vehicle with features and implementations similar to smart homes. Further, for example, vehicles are equipped with smart locks including remote unlock and/or proximity unlock functionality. In addition, for example, a rider is prompted to identify their ride, approach the vehicle, and tap their mobile device at an appropriate location and/or request a remote unlock. Moreover, for example, a vehicle is provided with NFC and/or Bluetooth locks and DLP headlights. It is noted that some or all of the hardware required to implement NFC and/or Bluetooth locks is also programmable for operation of DLP headlights. Furthermore, for example, a vehicle provided with NFC and/or Bluetooth locks and DLP headlights reduces problems encountered with smart locks alone. For instance, smart locks alone frustrate users as the locks do not provide immediate feedback as to why a vehicle is not unlocking (e.g., when a user attempts to board a vehicle from the wrong ride). Also, for instance, smart locks alone can have a range of several hundred feet, resulting in a problem of a user unintentionally standing in front of the wrong vehicle while unlocking the actual vehicle located a distance from the user.

In some embodiments, a machine-readable code (e.g., an unlock code) is displayed on or near (e.g., in front of or on the sidewalk adjacent to) the vehicle. For example, the machine-readable code is provided to verify both driver and rider for a ride with a ride-sharing service. Also, for example, in combination with features and embodiments described herein, active vehicle paint displays a machine-readable code (e.g., an unlock code). Further, for example, biometric information (e.g., fingerprints and/or facial identification data) are provided to a web service (e.g., ride-sharing service). In addition, for example, biometric information is validated by the vehicle. Moreover, for example, biometric information is validated by the vehicle utilizing one or more dedicated sensors (e.g., a fingerprint reader, and/or ADAS cameras). Furthermore, for example, a rider is identified using one or more imaging sensors. Additionally, for example, a rider is identified by the rider performing one or more gestures. Still further, for example, at least one of or all of the features are provided in a single system including at least one of displaying the machine-readable code on or near the vehicle, providing the machine-readable code to verify both driver and rider for the ride with the ride-sharing service, displaying the machine-readable code with active vehicle paint, providing biometric information to the web service, validating the biometric information by the vehicle, validating the biometric information by the vehicle utilizing one or more dedicated sensors, identifying the rider performing one or more gestures, combinations of the same, or the like.

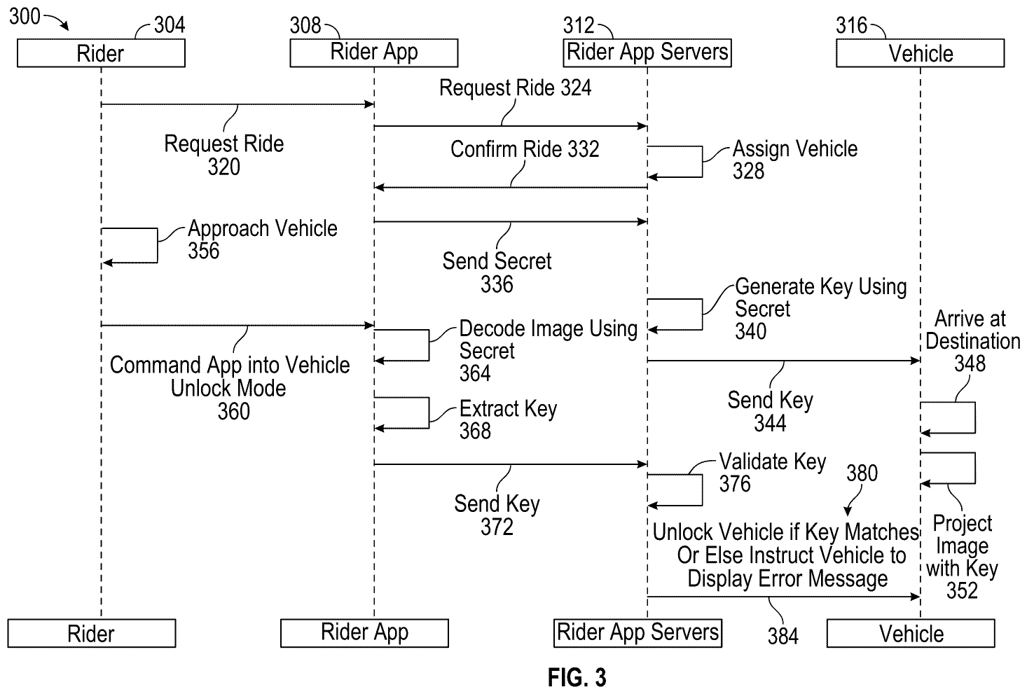

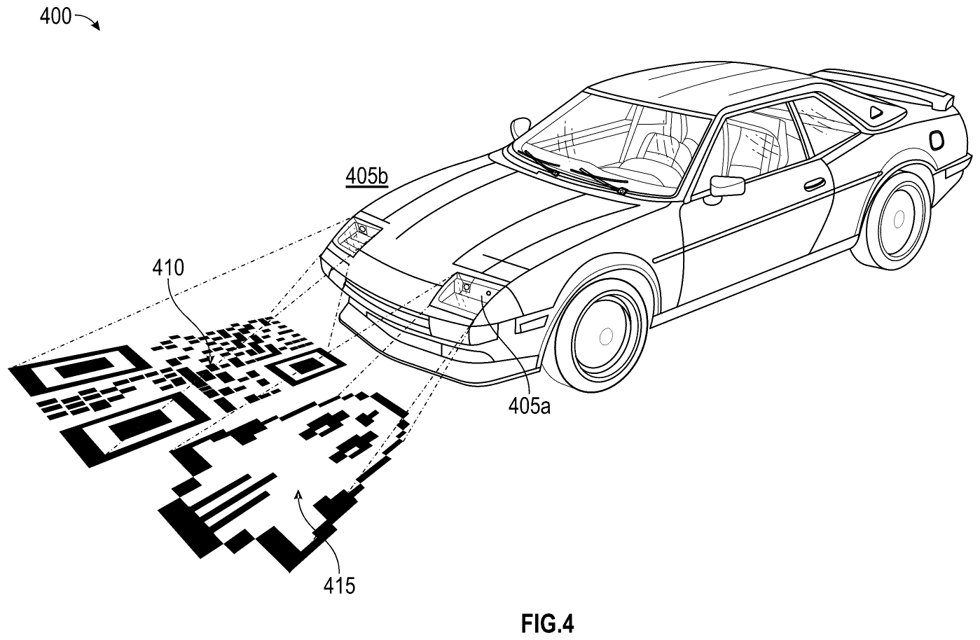

FIG. 3 depicts an example process 300 for system exchanges for automated ride validation, in accordance with some embodiments of the disclosure. In some embodiments, a vehicle 316 is fitted with one or more programmable DLP headlights. For example, a headlight is programmed to display one or more low-resolution symbols, such as one or more QR codes and/or pixel art as illustrated in FIG. 4.

In some embodiments, a process for automated ride validation is provided. The process involves a system of exchanges between a rider, a rider app, rider app servers, and a vehicle. The vehicle is equipped, e.g., with programmable DLP headlights that can display, e.g., low-resolution symbols such as QR codes or pixel art. The process begins with the rider requesting a ride via the rider app. The request is received and processed by the rider app servers, which then assign a vehicle to the rider. The servers confirm the ride and exchange information with the rider app. A secret is sent by the rider app to the servers. The secret is then used to generate a key (e.g., an encrypted key). This key is sent to the vehicle and displayed as an image projected by the vehicle's, e.g., DLP headlights. The rider approaches the vehicle, commands the rider app into a vehicle unlock mode, and decodes the image using the secret to extract the key. The key is sent back to the servers for validation. If the key matches, the servers unlock the vehicle. If not, the servers instruct the vehicle to display (e.g., project) an error message. The process ensures a secure and automated ride validation system.

In some embodiments, the process 300 includes communication between at least one of a rider 304, a rider app 308 (e.g., installed on a user device controlled by the rider 304), one or more rider app servers 312, the vehicle 316, combinations of the same, or the like. For example, the process 300 includes the rider 304 requesting 320 a ride, e.g., by entering a ride request via the rider app 308. Also, for example, the process 300 includes the rider app 308 receiving the request.

Further, for example, the process 300 includes the rider app 308 requesting 324 the ride, e.g., by sending the request to the one or more rider app servers 312. In addition, for example, the process 300 includes the one or more rider app servers 312 receiving the request. Moreover, for example, the process 300 includes the one or more ride app servers 312 assigning 328 the vehicle 316 (e.g., from among a selection of vehicles made available for selection by the rider 304). Furthermore, for example, the process 300 includes the one or more ride app servers 312 confirming 332 the ride, e.g., by the one or more rider app servers 312 exchanging information with the rider app 308. Additionally, for example, the process 300 includes the rider app 308 receiving the confirmed ride. Still further, for example, the process 300 includes the rider app 308 sending 336 a secret to the one or more rider app servers 312. Even further, for example, the process 300 includes the one or more rider app servers 312 receiving the secret. Yet further, for example, the process 300 includes the one or more rider app servers 312 generating 340 a key using the secret. Also, for example, the process 300 includes the one or more rider app servers 312 sending 344 the key to the vehicle 316 (e.g., a driver app on a device operated by a driver of the vehicle 316). Further, for example, the process 300 includes the vehicle 316 receiving the key.

In addition, for example, the process 300 includes the vehicle 316 arriving 348 at a destination and/or a location of the rider 304. Moreover, for example, the process 300 includes the vehicle 316 projecting 352 an image with the key, e.g., with a projector, e.g., a megapixel projector, e.g., DLP headlights.

Furthermore, for example, the process 300 includes the rider 304 approaching 356 the vehicle 316. Additionally, for example, the process 300 includes the rider 304 commanding 360 the rider app 308 into a vehicle unlock mode.

Still further, for example, the process 300 includes the rider app 308 decoding 364 the image using the secret. Even further, for example, the process 300 includes the rider app 308 extracting 368 the key. Yet further, for example, the process 300 includes the rider app 308 sending 372 the key to the one or more ride app servers 312. Also, for example, the process 300 includes the one or more rider app servers 312 receiving the key.

Further, for example, the process 300 includes the one or more rider app servers 312 validating 376 the key. In addition, for example, the process 300 includes the one or more rider app servers 312 unlocking 380 the vehicle if the key matches. Moreover, alternatively, for example, the process 300 includes the one or more rider app servers 312 instructing 384 the vehicle 316 to display an error message. Furthermore, for example, the process 300 includes the vehicle 316 receiving the instruction to display the error message.

FIG. 4 depicts an example autonomous vehicle 400 with DLP headlights 405a, 405b displaying one or more symbols in front of the vehicle, in accordance with some embodiments of the disclosure. For example, a ride-sharing application is programmed so that when the autonomous vehicle 400 arrives in proximity of its intended rider, it commands the headlights 405a, 405b to display at least one machine-readable image in close vicinity of the front of the vehicle (as illustrated in FIG. 4). Also, for example, the at least one machine-readable image includes a machine-readable unlock code 410 and/or a human-readable location code 415. Further, for example, the vehicle 400 may display a similar pattern using its taillights (not shown). In addition, for example, the vehicle 400 may use both headlights 405a, 405b and taillights to display one or more images.

In some embodiments, the machine-readable code may then be scanned by the rider using the ride-sharing application (not shown). The ride-sharing application may then decode the machine-readable code using a secret that was previously shared with the vehicle. Upon verification that the code is indeed valid, the ride-sharing application may then instruct the vehicle to unlock, allowing the rider to board. In an embodiment, upon verification, the vehicle may project a different code or message to confirm, so that other people know that it is the right rider, and that the vehicle is now unlocked.

In some embodiments, referring to FIG. 2, the headlight controller 220 receives both an image and projection instructions from a remote robotaxi management service. For example, the projection instructions are computed by the robotaxi service based on the environment scan 230 from the vehicle 205. Also, for example, the environment scan 230 is an aggregation of a subset of the vehicle's external sensor readings. Further, for example, the environment scan 230 is built from the images or videos collected by the external cameras (e.g., 207a-207f) installed on the vehicle to measure its surroundings. In addition, for example, the environment scan 230 includes data collected from a lidar sensor. Moreover, for example, the environment scan 230 includes GPS coordinates and other location information. Furthermore, for example, based on the environment scan 230, the robotaxi service generates a set of environment metadata 255 that it turns into a set of DLP instructions, e.g., 285. Additionally, for example, the DLP instructions include at least one of colors, intensity, projection angle, or the like that inform the DLP headlights (e.g., 222a, 222b) how to project an image. Still further, for example, based on the environment scan 230, the robotaxi server detects that the vehicle 205 is parked near a wall and instructs the DLP headlights to project the image on that wall. Even further, for example, based on the environment scan 230, the robotaxi server detects that the vehicle 205 is in a street near another vehicle and instructs the DLP headlights to project the image on the street surface. Yet further, for example, the robotaxi service determines the amount of space the vehicle has to project the image on the street and instructs the DLP headlights to scale the image it receives accordingly.

In some embodiments, a system and method for identifying a specific vehicle in a crowded pickup area using modulated light signals is provided. In crowded pickup areas, it can be challenging for a user to identify their ride when multiple vehicles are lined up closely. Traditional methods such as displaying a taxi sign or license plate may not be sufficient or convenient for the user. Moreover, projections on the ground may not be visible in full sunlight or may require sufficient ground space. For example, modulated light signals are provided. Also, for example, the headlight of the vehicle emits a modulated signal that is detectable by a phone camera. Alternatively, for example, the user's phone flashlight emits a signal, including a shared token, to the vehicle's camera. Further, for example, the system operates in both directions. The system does not limit the projection to the front of the vehicle. While the front is straightforward because headlights are already present, installing DLP lights on the side for projection on the curb is also provided. This allows for a minimum projection on the curb side, which could be beneficial in certain situations. The user does not have to scan the front plate of every vehicle they think might be their ride. They could wait until they see a pattern. This facilitates easy location by the rider of their ride.

In some embodiments, the vehicle and the ride-sharing application agree on a human-readable code (e.g., 415) to display in complement to the machine-readable code (e.g., 410) to allow a rider to quickly locate or identify their ride. For example, the system allows users to choose the pattern, color, code, or even animation of the projection through the ride-sharing app. Also, for example, this personalization makes it easier for riders to identify their vehicle. Further, for example, in combination with the features above, at least one additional function is provided, including displaying a particular color on a ride-sharing vehicle windshield, changing the color of the vehicle based on a user's profile, or the like.

In some embodiments, the vehicle first displays the human-readable code. For example, upon detecting the rider in close proximity to the vehicle (e.g., using GPS location), camera localization or any other localization method is provided. Also, for example, the vehicle switches to the machine-readable code. Further, for example, the intended rider scans the machine-readable code to unlock the vehicle.

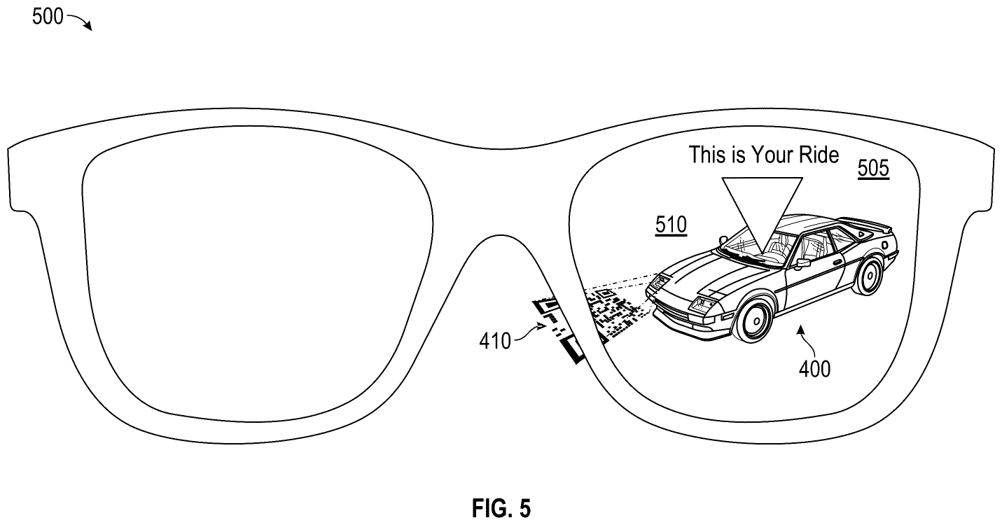

In some embodiments, a machine-readable code is used by an augmented reality (AR) device coupled to a ride-sharing application to identify a ride. FIG. 5 depicts an example AR device 500 (e.g., AR glasses) for identifying a ride-sharing vehicle 400, in accordance with some embodiments of the disclosure. For example, in FIG. 5, the ride-sharing application communicates with the AR device 500 and supplies a representation of a machine-readable code that the assigned vehicle is going to display. Also, for example, the AR device 500 uses one or more computer vision techniques to match an incoming vehicle and its associated machine-readable code 410 with the provided machine-readable code to identify the proper vehicle.

Further, for example, as shown in FIG. 5, from a perspective of a viewer looking through the AR device 500 at the vehicle 400, the AR device 500 informs the rider with a message 505, such as “THIS IS YOUR RIDE,” and/or with an indicator, such as an arrow icon 510 pointing to the identified vehicle 400.

In some embodiments, upon the rider scanning the code to unlock a first vehicle and detecting that it is not the assigned vehicle for that rider, the ride-sharing application displays a warning message to the rider informing them of the location of their assigned vehicle relative to the first vehicle. For example, the ride-sharing application re-assigns the first vehicle to the first rider if it is detected that a second rider assigned to the first vehicle is not yet at their intended pick-up location, and the second vehicle formerly assigned to the first rider has also arrived at the pick-up location.

In some embodiments, the machine-readable code includes a series of images. For example, the series of images accounts for limited rendering capabilities of some headlights. Also, for example, a machine-readable code includes a repeated series of images pulsated at a relatively high speed so that the images are not detectable by the human eye. Further, for example, a cyclically repeated sequence of machine-readable codes is provided, e.g., capturing any 30 continuous images results in decoding the code.

In some embodiments, based at least in part on a rider confirmed by a scanning and/or verification process, a device of the rider is automatically connected to a Wi-Fi network of the vehicle. For example, upon scanning and/or verification, vehicle settings are adjusted to match a profile of the verified user. Also, for example, upon scanning and/or verification, a seat setting and/or an air conditioning setting is set in accordance with the profile of the verified user.

Further, for example, upon scanning and/or verification, content (e.g., music and/or video) is played (and/or queued up for playback) on one or more devices (e.g., in the vehicle) in accordance with the profile of the verified user. In addition, for example, upon scanning and/or verification, content on the device of the verified user is automatically connected to one or more devices of the vehicle.

In some embodiments, the user captures, with a user device, an image or scan of a vehicle together with a projected image. For example, the captured image or scan is shared with the rideshare app, and verification is performed through image recognition.

In some embodiments, autonomous vehicle services are provided. For example, a system is provided for enhancing user interaction and service allocation through use of image projection at designated areas. For example, a designated image projection system comprises a projection device installed in a robotaxi and a designated projection area located at the pickup spot. Also, for example, the projection device is configured to project an image onto the designated projection area upon the robotaxi's arrival. Further, for example, the image includes a logo, a unique identifier, or any other image that allows users to identify their assigned robotaxi. In addition, for example, the system includes a user interface, such as a user interface accessible via a mobile application, which allows users to scan the projected image to confirm their robotaxi. In addition, for example, the user interface provides a platform for users to participate in a bidding process for the current available robotaxi. Moreover, for example, the system provides an efficient and user-friendly method for users to identify their assigned robotaxi. Furthermore, for example, the system optimizes the allocation of robotaxis by allowing users to bid for the current available robotaxi. Additionally, for example, the designated image projection system is implemented in any environment where robotaxi services are provided. Still further, for example, the system is effective in crowded or complex environments, where traditional methods of identifying vehicles are challenging. Even further, for example, the bidding mechanism optimizes the allocation of robotaxis during peak times or in high-demand areas.

Ride sharing and robotaxis represent two of many applications. Similar systems and processes are provided for food delivery, parcel delivery, car rental, public transportation, ridesharing for disabled individuals, or the like. For example, the process is adapted for food delivery services. The delivery vehicle is equipped with programmable DLP headlights. When the delivery vehicle arrives at the customer's location, it projects an image with a key. The customer uses their food delivery app to decode the image and confirm the delivery. This adds an extra layer of security and verification to the food delivery process. Also, for example, similar to the food delivery scenario, the process is provided for parcel delivery services. The delivery vehicle projects an image with a key when it arrives at the recipient's location. The recipient uses their parcel tracking app to decode the image and confirm receipt of the parcel. This prevents parcel theft and ensures that the parcel is delivered to the correct recipient. Further, for example, in car rental services, the process is provided to unlock the rental car. Once the customer books a car, the rental app servers generate a key and send it to the car. When the customer approaches the car, the car projects an image with the key. The customer uses their car rental app to decode the image and unlock the car. This provides a seamless and secure experience of identifying a rented car. In addition, for example, in public transportation services like buses or trams, the process is provided for ticket validation. The vehicle projects an image with a key when it arrives at the station. The passengers use their transportation app to decode the image and validate their tickets. This automates ticket validation and improves the efficiency of public transportation services. Moreover, for example, for ride-sharing services specifically designed for disabled individuals, the process is adapted to project images that are easier for these individuals to recognize, such as high-contrast images or images in specific color schemes. This makes the ride-sharing experience more accessible for disabled individuals. Also, this allows additional avenues for display of content, such as advertisements.

Methods for controlling a vehicle's megapixel projector using sensor data are provided. These methods involve generating an environmental scan, interacting with a mobile application, adjusting the image based on local conditions, and monitoring the driver's condition. They also consider environmental factors like illumination and weather, and detect specific conditions like inconsistent light levels or shadows. The image for projection is selected based on a user profile and can include hazard identification and direction cues. Some processes involve steps performed at a web service, including receiving an environmental scan, sending environmental metadata, and receiving control information. A unique validation image is projected for ride services, which can be scanned by a user device to unlock the vehicle. These processes effectively control a vehicle's megapixel projector.

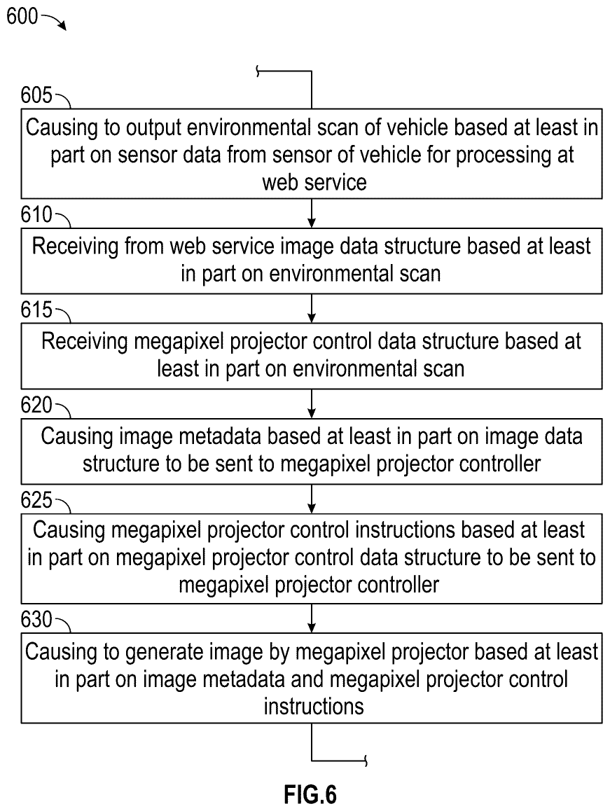

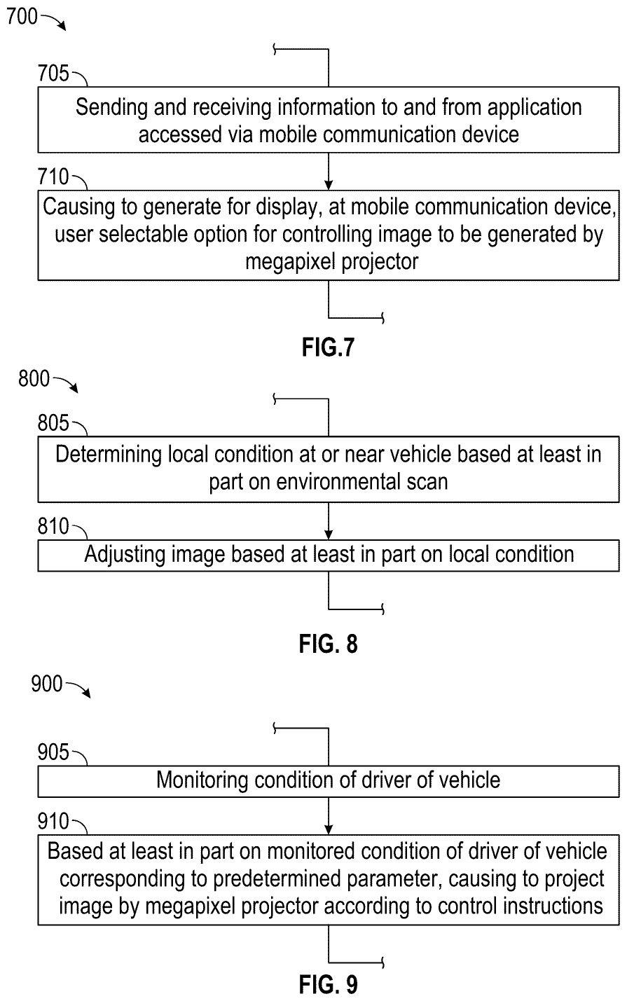

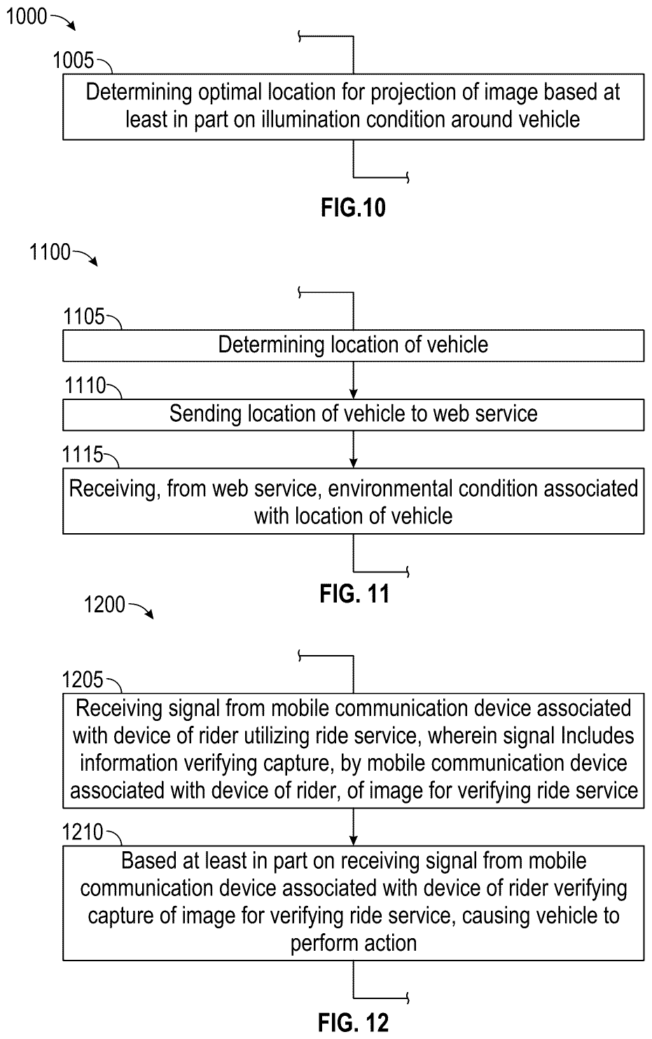

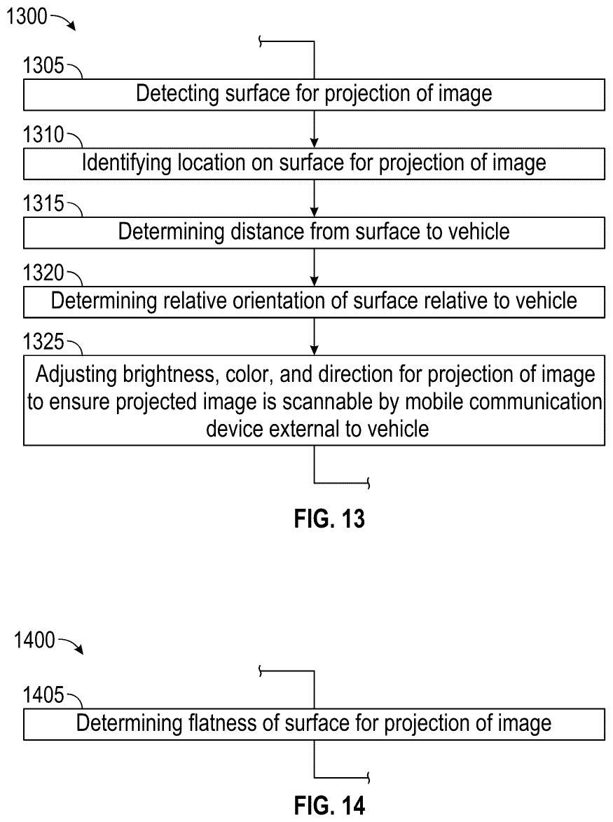

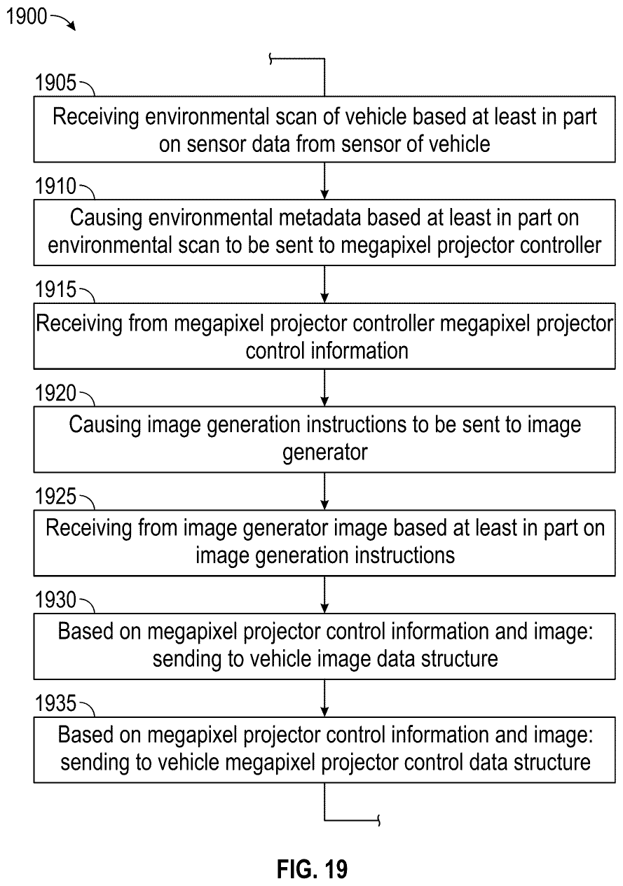

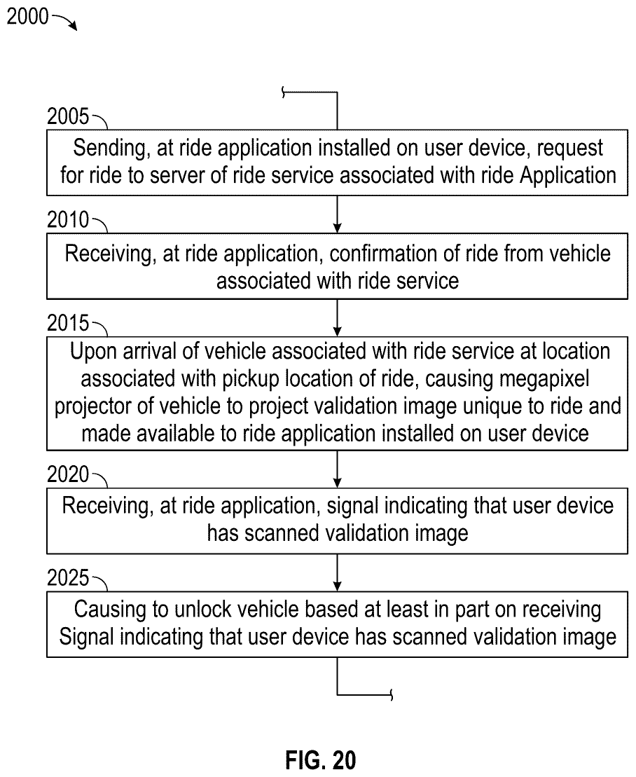

FIGS. 6-20 illustrate various example methods for controlling a vehicle's megapixel projector. For example, an example method controls a vehicle's megapixel projector using sensor data, which includes steps such as generating an environmental scan, receiving image and control data structures from a web service, and sending image metadata and control instructions to the projector controller, ultimately leading to the generation of an image by the projector. Various additional processes are provided. These additional processes, examples of which are depicted in FIGS. 7-18, encompass a range of functionalities. For instance, FIG. 7 outlines a process that involves interaction with a mobile application, offering user-selectable options for controlling the projected image. FIG. 8 focuses on adjusting the image based on local conditions near the vehicle. In FIG. 9, the process monitors the driver's condition and adjusts the projector accordingly. FIGS. 10 and 11 detail how environmental factors, such as illumination and weather conditions, influence the projection. FIG. 12 introduces a verification process for ride services, using the projector to display an image that can be captured and verified by a rider's mobile device. FIGS. 13-15 discuss the considerations for projecting the image onto a surface, including detecting the surface, determining the optimal location and orientation for projection, and adjusting the image's brightness, color, or direction based on these factors. FIGS. 16 and 17 highlight the detection of specific conditions, such as inconsistent light levels or shadows cast by the vehicle, which may affect the projection. These processes collectively contribute to the effective control of a vehicle's megapixel projector. FIG. 18 introduces a process where the image for projection is selected based on a user profile. In some embodiments, the megapixel projector, which could be a DLP projector for one or more headlights of the vehicle, projects an image that includes identification of a hazard and a direction cue that avoids the hazard. FIG. 19 outlines a process that involves steps performed at a web service. This process includes receiving an environmental scan of the vehicle, sending environmental metadata to a megapixel projector controller, and receiving control information from the controller. Image generation instructions are sent to an image generator, and an image is received from the generator. Based on the control information and the image, an image data structure and a megapixel projector control data structure are sent to the vehicle. Image metadata and control instructions are then sent to the megapixel projector controller, leading to the generation of an image by the projector. FIG. 20 depicts a process related to a ride service application installed on a user device. Upon confirmation of a ride request and arrival of the vehicle at the pickup location, a unique validation image is projected by the vehicle's megapixel projector. The user device scans the validation image, and upon receiving a signal indicating successful scanning, the vehicle is unlocked. The validation image can be directed towards a location of an external user or a particular point of interest. This process, like some others, involves a DLP projector for one or more headlights of the vehicle.

FIG. 6 depicts an example process 600 for controlling a megapixel projector of a vehicle including a sensor, in accordance with some embodiments of the disclosure. For example, the process 600 includes one or more steps performed at the vehicle. Also, for example, the process 600 includes causing 605 to output an environmental scan of the vehicle based at least in part on sensor data from the sensor of the vehicle for processing at a web service. Further, for example, the process 600 includes receiving 610 from the web service an image data structure based at least in part on the environmental scan. In addition, for example, the process 600 includes receiving 615 a megapixel projector control data structure based at least in part on the environmental scan. Moreover, for example, the process 600 includes causing 620 image metadata based at least in part on the image data structure to be sent to a megapixel projector controller. Furthermore, for example, the process 600 includes causing 625 megapixel projector control instructions based at least in part on the megapixel projector control data structure to be sent to the megapixel projector controller. Additionally, for example, the process 600 includes causing 630 to generate an image by the megapixel projector based at least in part on the image metadata and the megapixel projector control instructions.

FIG. 7 depicts an example process 700 for controlling a megapixel projector of a vehicle including a sensor, in accordance with some embodiments of the disclosure. For example, the process 700 includes sending and receiving 705 information to and from an application accessed via a mobile communication device. Also, for example, the process 700 includes causing 710 to generate for display, at the mobile communication device, a user-selectable option for controlling the image to be generated by the megapixel projector. Further, for example, the process 700 includes, for the causing 710 to generate for display, at the mobile communication device, the user-selectable option for controlling the image to be generated by the megapixel projector, at least one of an option for associating the image with a location of the vehicle, an option to display the image to be generated by the megapixel projector, or an option to display the image to be generated by the megapixel projector in an environment where the image is to be displayed.

It is noted that the user-selectable option is not limited to controlling the image to be generated by the megapixel projector. For example, one or more user-selectable options are provided for selection of one or more elements to be projected. Also, for example, a navigation system inside the vehicle displays a screen with different elements, such as at least one of a navigation direction (e.g., on a top-right side of the screen), one or more icons representing one or more points of interest (e.g., gas stations, restaurants, or the like), on or associated with display of a map, a time to destination, a distance to destination, combinations of the same, or the like. Further, for example, one or more user-selectable options are provided to select the elements and make them projection-eligible. In addition, for example, when one or more changes occur (e.g., an upcoming gas station), then an image is projected appropriate to the situation. Moreover, for example, based on a signal that a vehicle is low on fuel or power, one or more navigation icons include projection of a location of a gas station or the like.

FIG. 8 depicts an example process 800 for controlling a megapixel projector of a vehicle including a sensor, in accordance with some embodiments of the disclosure. For example, the process 800 includes determining 805 a local condition at or near the vehicle based at least in part on the environmental scan. Also, for example, the process 800 includes adjusting 810 the image based at least in part on the local condition.

FIG. 9 depicts an example process 900 for controlling a megapixel projector of a vehicle including a sensor, in accordance with some embodiments of the disclosure. For example, the process 900 includes monitoring a condition of a driver of the vehicle. Also, for example, the process 900 includes based at least in part on the monitored condition of the driver of the vehicle corresponding to a predetermined parameter, causing 910 to project the image by the megapixel projector according to the control instructions. Further, for example, the condition is at least one of drowsiness, fatigue, distraction, an irregular driving pattern, frequent lane changes, excessive speed, or following too closely to another vehicle.

FIG. 10 depicts an example process 1000 for controlling a megapixel projector of a vehicle including a sensor, in accordance with some embodiments of the disclosure. For example, the environmental scan includes an illumination condition around the vehicle. Also, for example, the process 1000 includes 1005 determining an optimal location for projection of the image based at least in part on the illumination condition around the vehicle.

Further, for example, the control instructions include information corresponding to the optimal location for projection of the image.

FIG. 11 depicts an example process 1100 for controlling a megapixel projector of a vehicle including a sensor, in accordance with some embodiments of the disclosure. For example, the process 1100 includes determining 1105 a location of the vehicle. Also, for example, the process 1100 includes sending 1110 the location of the vehicle to a web service. Further, for example, the process 1100 includes receiving 1115, from the web service, an environmental condition associated with the location of the vehicle. In addition, for example, the image is generated based at least in part on the environmental condition associated with the location of the vehicle. Moreover, for example, the environmental condition includes a weather condition.

FIG. 12 depicts an example process 1200 for controlling a megapixel projector of a vehicle including a sensor, in accordance with some embodiments of the disclosure. For example, the image is an image for verifying a ride service. Also, for example, the process 1200 includes receiving 1205 a signal from a mobile communication device associated with a device of a rider utilizing the ride service. Further, for example, the signal includes information verifying capture, by the mobile communication device associated with the device of the rider, of the image for verifying the ride service. In addition, for example, the process 1200 includes based at least in part on receiving the signal from the mobile communication device associated with the device of the rider verifying the capture of the image for verifying the ride service, causing 1210 the vehicle to perform an action. Moreover, for example, the ride service is a robotaxi service. Furthermore, for example, the action is unlocking the vehicle.

FIG. 13 depicts an example process 1300 for controlling a megapixel projector of a vehicle including a sensor, in accordance with some embodiments of the disclosure. For example, the process 1300 includes detecting 1305 a surface for projection of the image. Also, for example, the process 1300 includes identifying 1310 a location on the surface for projection of the image. Further, for example, the process 1300 includes determining 1315 a distance from the surface to the vehicle. In addition, for example, the process 1300 includes determining 1320 a relative orientation of the surface relative to the vehicle. Moreover, for example, the control instructions and the image instructions for projection of the image on the surface are based at least in part on the location on the surface for projection of the image, the distance from the surface to the vehicle, and the relative orientation of the surface relative to the vehicle.

Furthermore, for example, the process 1300 includes adjusting 1325 at least one of a brightness, a color, or a direction for projection of the image to ensure the projected image is scannable by a mobile communication device external to the vehicle. Additionally, for example, the adjusting of the at least one of the brightness, the color, or the direction for the projection of the image to ensure the projected image is scannable by the mobile communication device external to the vehicle is based at least in part on a location of the mobile communication device.

FIG. 14 depicts an example process 1400 for controlling a megapixel projector of a vehicle including a sensor, in accordance with some embodiments of the disclosure. For example, the process 1400 includes determining 1405 a flatness of the surface for projection of the image. Also, for example, the control instructions and the image instructions for projection of the image on the surface are based at least in part on the flatness of the surface for projection of the image.

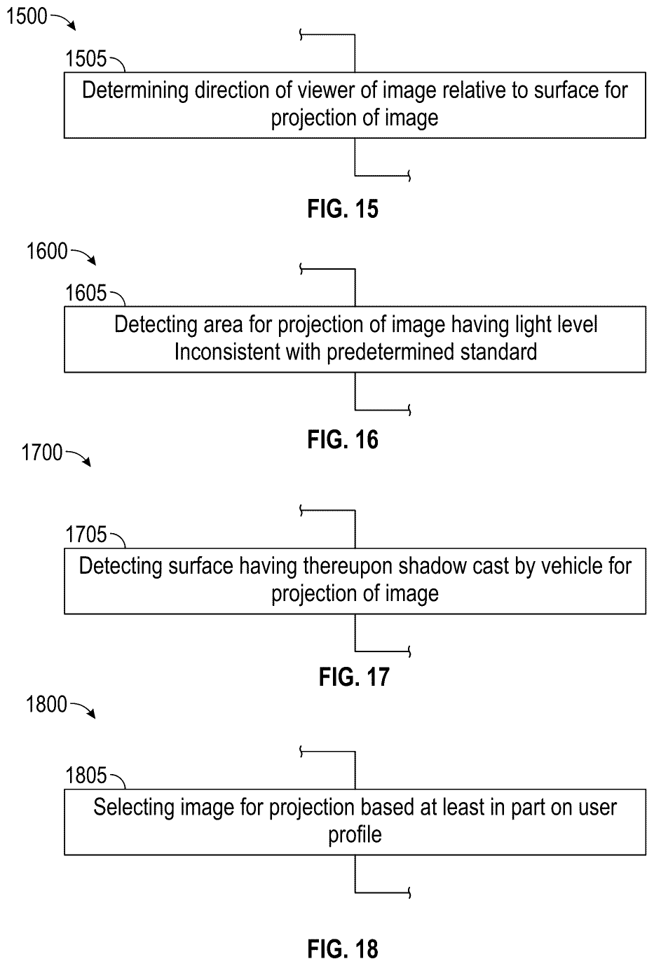

FIG. 15 depicts an example process 1500 for controlling a megapixel projector of a vehicle including a sensor, in accordance with some embodiments of the disclosure. For example, the process 1500 includes determining 1505 a direction of a viewer of the image relative to the surface for projection of the image. Also, for example, the control instructions and the image instructions for projection of the image on the surface are based at least in part on the direction of the viewer of the image relative to the surface for projection of the image.

FIG. 16 depicts an example process 1600 for controlling a megapixel projector of a vehicle including a sensor, in accordance with some embodiments of the disclosure. For example, the process 1600 includes detecting 1605 an area for projection of the image having a light level inconsistent with a predetermined standard.

FIG. 17 depicts an example process 1700 for controlling a megapixel projector of a vehicle including a sensor, in accordance with some embodiments of the disclosure. For example, the process 1700 includes detecting 1705 a surface having thereupon a shadow cast by the vehicle for projection of the image.

FIG. 18 depicts an example process 1800 for controlling a megapixel projector of a vehicle including a sensor, in accordance with some embodiments of the disclosure. For example, the process 1800 includes selecting 1805 the image for projection based at least in part on a user profile.

In some embodiments, for example, the megapixel projector is a DLP projector for one or more headlights of the vehicle. Also, for example, the image includes identification of a hazard. Further, for example, the image includes a direction cue. In addition, for example, the image includes identification of a hazard and a direction cue that avoids the hazard.

FIG. 19 depicts an example process 1900 for controlling a megapixel projector of a vehicle including a sensor, in accordance with some embodiments of the disclosure. For example, the process 1900 includes one or more steps performed at a web service. Also, for example, the process 1900 includes receiving 1905 an environmental scan of the vehicle based at least in part on sensor data from the sensor of the vehicle. Further, for example, the process 1900 includes causing 1910 environmental metadata based at least in part on the environmental scan to be sent to a megapixel projector controller. In addition, for example, the process 1900 includes receiving 1915 from the megapixel projector controller megapixel projector control information. Moreover, for example, the process 1900 includes causing 1920 image generation instructions to be sent to an image generator, wherein the image generation instructions are based at least in part on the environmental scan. Furthermore, for example, the process 1900 includes receiving 1925 from the image generator an image based at least in part on the image generation instructions.

Additionally, for example, the process 1900 includes based on the megapixel projector control information and the image: sending 1930 to the vehicle an image data structure. Still further, for example, the process 1900 includes based on the megapixel projector control information and the image: sending 1935 to the vehicle a megapixel projector control data structure. Even further, for example, image metadata based at least in part on the image data structure are caused to be sent to a megapixel projector controller. Yet further, for example, megapixel projector control instructions based at least in part on the megapixel projector control data structure are caused to be sent to the megapixel projector controller. Also, for example, an image is caused to be generated by the megapixel projector according to the image metadata and the megapixel projector control instructions. Further, for example, the megapixel projector is a DLP projector for one or more headlights of the vehicle.

FIG. 20 depicts an example process 2000 for controlling a megapixel projector of a vehicle including a sensor, in accordance with some embodiments of the disclosure. For example, the process 2000 includes sending 2005, at a ride application installed on a user device, a request for a ride to a server of a ride service associated with the ride application. Also, for example, the process 2000 includes receiving 2010, at the ride application, a confirmation of the ride from the vehicle associated with the ride service. Further, for example, the process 2000 includes upon arrival of the vehicle associated with the ride service at a location associated with a pickup location of the ride, causing 2015 the megapixel projector of the vehicle to project a validation image unique to the ride and made available to the ride application installed on the user device. In addition, for example, the process 2000 includes receiving 2020, at the ride application, a signal indicating that the user device has scanned the validation image. Moreover, for example, the process 2000 includes causing 2025 to unlock the vehicle based at least in part on receiving the signal indicating that the user device has scanned the validation image. Furthermore, for example, the validation image is directed towards a location of an external user. Additionally, for example, the validation image is directed towards a particular point of interest. Still further, for example, the megapixel projector is a DLP projector for one or more headlights of the vehicle.

Although some examples herein relate to headlights for a vehicle, additional applications are provided in the fields of home automation, industrial automation, retail, advertising, education, and training. For example, methods are provided for controlling a home automation system's projector. For instance, sensor data from various home devices are used to generate an environmental scan. This data is used to control the projector, adjusting the projected image based on local conditions within the home. The projector also interacts with a mobile application, offering user-selectable options for controlling the projected image. The image is adjusted based on factors such as room illumination and weather conditions. The projector also displays images that are captured and verified by a user's mobile device for security purposes.

Also, for example, in an industrial setting, a method is provided to control a projector used for displaying important information. The projector adjusts the image based on local conditions in the industrial environment. It also interacts with a mobile application, offering user-selectable options for controlling the projected image. The image is adjusted based on factors such as illumination and weather conditions in the industrial environment. The projector also displays images that are captured and verified by a worker's mobile device for safety or security purposes.

Further, for example, in a retail or advertising context, a method is provided to control a projector used for displaying advertisements or other information. The projector adjusts the image based on local conditions in the retail environment. It also interacts with a mobile application, offering user-selectable options for controlling the projected image. The image is adjusted based on factors such as illumination and weather conditions in the retail environment. The projector also displays images that can be captured and verified by a customer's mobile device for interactive advertising purposes.

In addition, for example, in an educational or training context, a method is provided to control a projector used for displaying educational content. The projector adjusts the image based on local conditions in the classroom or training environment. It also interacts with a mobile application, offering user-selectable options for controlling the projected image. The image is adjusted based on factors such as illumination and weather conditions in the educational environment. The projector also displays images that are captured and verified by a student's or trainee's mobile device for interactive learning purposes.

### INCORPORATION BY REFERENCE

The following is hereby incorporated by reference herein in its entirety: Jean-Yves Couleaud, Serhad Doken, and Ning Xu, U.S. patent application Ser. No. 18/244,076, titled “System and Methods to Modify Active Car Paint,”filed Sep. 8, 2023.

### Predictive Model

In some embodiments, one or more artificial intelligence (AI) models and/or tools are employed to enhance the functionality disclosed herein. The one or more AI models and/or tools include at least one of environmental data processing, user interaction prediction, vehicle location analysis, local condition analysis, driver condition monitoring, illumination analysis, environmental condition prediction, ride service verification, surface detection and projection adjustment, viewer direction determination, light level detection, shadow detection, image selection, DLP projector control, hazard identification, web service processing, combinations of the same, or the like.

For example, for environmental data processing, an AI model processes environmental scan data from a vehicle's sensor. It identifies and classifies objects in the environment, which are used to generate an image data structure and a megapixel projector control data structure. The model also predicts future states of the environment based on past and current sensor data, adjusting the image and control metadata in real-time. For instance, a convolutional neural network (CNN) is used for object detection and classification.

Also, for example, for user interaction prediction, a predictive model anticipates the user's selections on a mobile communication device based on their past interactions. This pre-generates user-selectable options for controlling the image generated by the megapixel projector, improving system responsiveness. A recurrent neural network (RNN), for example, is used for this purpose, given its ability to process sequential data.

Further, for example, for vehicle location analysis. AI analyzes the environmental scan to determine the vehicle's location, generating user-selectable options for associating the image with the vehicle's location. This involves GPS data and mapping APIs, for example.

In addition, for example, for local condition analysis, machine learning algorithms analyze the environmental scan to determine local conditions near the vehicle, adjusting the image accordingly. This involves using a decision tree model to classify weather conditions, for example.

Moreover, for example, for driver condition monitoring, AI monitors the driver's condition. Computer vision algorithms detect signs of drowsiness, fatigue, or distraction in the driver, adjusting the projected image if these conditions are detected. This involves using a CNN for facial expression recognition, for example.

Furthermore, for example, for illumination analysis, AI analyzes the illumination condition around the vehicle and determines the optimal location for image projection, ensuring clear visibility in all lighting conditions. For example, this involves using a light sensor and a model trained to optimize image projection based on light data.

Additionally, for example, for environmental condition prediction, a predictive model anticipates environmental conditions associated with the vehicle's location, adjusting the image accordingly. This involves a model trained on historical weather data and vehicle location data, for example.

Still further, for example, for ride service verification, AI verifies the ride service. An image recognition algorithm verifies the capture of the image for verifying the ride service. In the case of a robotaxi service, AI manages the entire ride service process, from verifying the ride service to unlocking the vehicle.

Even further, for example, for surface detection and projection adjustment, AI detects the surface for image projection, identifies the location on the surface for projection, and determines the distance from the surface to the vehicle. This information adjusts the control instructions and image instructions. AI also adjusts the brightness, color, and direction of the projected image to ensure it is scannable by an external mobile communication device.

Yet further, for example, for viewer direction determination, AI determines the direction of the viewer of the image relative to the surface for projection, adjusting the control instructions and image instructions accordingly.

Also, for example, for light level detection, AI detects areas for image projection that have a light level inconsistent with a predetermined standard, adjusting the control instructions and image instructions accordingly.

Further, for example, for shadow detection, AI detects surfaces upon which a shadow cast by the vehicle is present for image projection, adjusting the control instructions and image instructions accordingly.

In addition, for example, for image selection, AI selects the image for projection based on a user profile, personalizing the system to the user's preferences.

Moreover, for example, for DLP projector control, AI controls a DLP projector for one or more headlights of the vehicle, improving visibility and safety.

Furthermore, for example, for hazard identification, AI identifies hazards in the environment and includes them in the image, improving vehicle safety. AI also generates direction cues in the image to guide the driver and improve safety. It identifies hazards in the environment and generates direction cues that avoid these hazards.

Additionally, for example, for web service processing, at the web service, AI processes the environmental scan of the vehicle, generates image generation instructions, and generates an image based on these instructions. This information generates the image data structure and the megapixel projector control data structure. The AI uses the DLP control information and the image to adjust the image metadata and the megapixel projector control metadata in real-time.

In some embodiments, one or more AI systems, AI methods, and trained models are provided. For example, a ride application installed on a user device sends a request for a ride to a server of a ride service associated with the application. This involves using a standard HTTP request to communicate with the server. An AI model is used to predict the demand for rides and optimize the allocation of vehicles. Also, for example, the ride application receives a confirmation of the ride from the vehicle associated with the ride service. This is facilitated by a push notification sent from the server to the ride application. Machine learning algorithms are used to estimate the arrival time of the vehicle based on traffic conditions and other factors. Further, for example, upon the vehicle's arrival at the pickup location, the vehicle's megapixel projector projects a validation image that is unique to the ride and made available to the ride application installed on the user device. This involves using a unique QR code or barcode as the validation image. An AI model generates the validation image in a way that is difficult to forge, enhancing the security of the system. In addition, for example, the ride application receives a signal indicating that the user device has scanned the validation image. This involves using the device's camera to scan the validation image and send a signal to the application. Computer vision algorithms are used to recognize the validation image accurately and quickly. Moreover, for example, the vehicle is unlocked based at least in part on receiving the signal indicating that the user device has scanned the validation image. This involves sending a signal from the ride application to the vehicle's locking system to unlock the vehicle. AI is used to detect any anomalies in the unlocking process and alert the system to potential security threats. Furthermore, for example, the validation image is directed towards a location of an external user. This involves using the vehicle's GPS and the user's location data to direct the projection of the validation image. Machine learning algorithms are used to predict the optimal location for the projection based on environmental conditions and user behavior. Additionally, for example, the validation image is directed towards a particular point of interest. This involves using the vehicle's GPS and a database of points of interest to direct the projection of the validation image. AI is used to identify points of interest that are likely to be visible and recognizable to the user.

Throughout the present disclosure, in some embodiments, determinations, predictions, likelihoods, and the like are determined with one or more predictive models. In some embodiments, the model receives various forms of data about users, vehicles, applications, media content items, devices, and more. This includes usage data, load-balancing data, and metadata. The model performs analysis based on hard rules, learning rules, hard models, learning models, usage data, load data, analytics, metadata, profile information, or combinations of these. The model outputs predictions of a future state of any of the devices described. Load-increasing events are determined by load-balancing processes. The model is based on inputs including hard rules, user-defined rules, rules defined by content providers, hard models, learning models, or combinations of these. The model is trained with data using various data processes, analytical processes, and machine learning approaches. It includes regression and classification analyses. An example of a multi-layer neural network is provided. The model is based on data engineering and modeling processes, and is operationalized using registration, deployment, monitoring, and retraining processes. The model is configured to output results to one or multiple devices, which can perform various functions. The devices can be a server, tablet, media display device, network-connected computer, media device, computing device, or combinations of these. The model outputs a current state, future state, determination, prediction, or likelihood. These outputs may be compared to a predetermined or determined standard. If the standard is satisfied or rejected, the predictive process outputs at least one of the current state, future state, determination, prediction, or likelihood to any device or module disclosed.

In some embodiments, the model ingests diverse forms of data about users, vehicles, applications, media content items, devices, and more. This encompasses user interaction data, load-distribution data, and metadata. The model conducts analysis based on deterministic rules, learned rules, deterministic models, learned models, user interaction data, load data, analytics, metadata, user profile information, or combinations thereof. The model generates predictions of a future state of any of the described devices. Load-increasing events are identified by load-distribution processes.

The model is constructed based on inputs including deterministic rules, user-defined rules, rules defined by content providers, deterministic models, learned models, or combinations thereof. The model is trained with data using various data processing methods, analytical processes, and machine learning techniques. It includes regression and classification analyses.

An example of a deep neural network is provided.

The model is built upon data engineering and modeling processes and is operationalized using registration, deployment, monitoring, and retraining processes. The model is designed to output results to one or multiple devices, which can perform various functions. The devices can be a server, tablet, digital display device, network-connected computer, media device, computing device, or combinations thereof.

The model outputs a current state, future state, determination, prediction, or probability. These outputs may be compared to a predetermined or determined benchmark. If the benchmark is met or not met, the predictive process outputs at least one of the current state, future state, determination, prediction, or probability to any device or module disclosed.

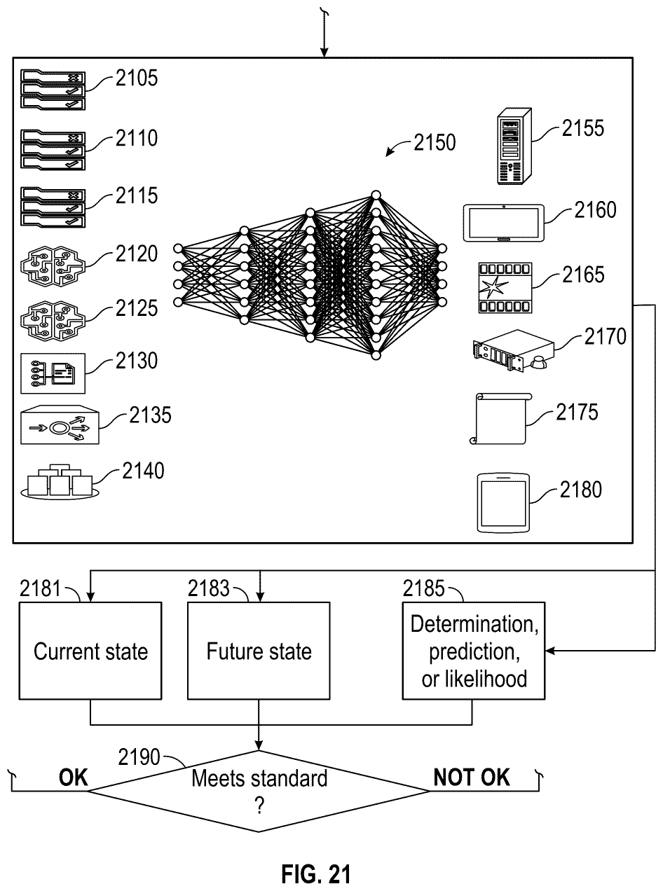

For example, FIG. 21 depicts a predictive model. A prediction process 2100 includes a predictive model 2150 in some embodiments. The predictive model 2150 receives as input various forms of data about one, more or all the users, vehicles, applications, media content items, devices, and data described in the present disclosure. The predictive model 2150 performs analysis based on at least one of hard rules, learning rules, hard models, learning models, usage data, load data, analytics of the same, metadata, profile information, combinations of the same, or the like. The predictive model 2150 outputs one or more predictions of a future state of any of the devices described in the present disclosure. A load-increasing event is determined by load-balancing processes, e.g., least connection, least bandwidth, round robin, server response time, weighted versions of the same, resource-based processes, and address hashing. The predictive model 2150 is based on input including at least one of a hard rule 2105, a user-defined rule 2110, a rule defined by a content provider 2115, a hard model 2120, a learning model 2125, combinations of the same, or the like.

The predictive model 2150 receives as input usage data 2130. The predictive model 2150 is based, in some embodiments, on at least one of a usage pattern of the user or media device, a usage pattern of the requesting media device, a usage pattern of the media content item, a usage pattern of the communication system or network, a usage pattern of the profile, a usage pattern of the media device, combinations of the same, or the like.

The predictive model 2150 receives as input load-balancing data 2135. The predictive model 2150 is based on at least one of load data of the display device, load data of the requesting media device, load data of the media content item, load data of the communication system or network, load data of the profile, load data of the media device, combinations of the same, or the like.

The predictive model 2150 receives as input metadata 2140. The predictive model 2150 is based on at least one of metadata of the streaming service, metadata of the requesting media device, metadata of the media content item, metadata of the communication system or network, metadata of the profile, metadata of the media device, combinations of the same, or the like. The metadata includes information of the type represented in the media device manifest.

The predictive model 2150 is trained with data. The training data is developed in some embodiments using one or more data processes including but not limited to data selection, data sourcing, and data synthesis. The predictive model 2150 is trained in some embodiments with one or more analytical processes including but not limited to classification and regression trees (CART), discrete choice models, linear regression models, logistic regression, logit versus probit, multinomial logistic regression, multivariate adaptive regression splines, probit regression, regression processes, survival or duration analysis, and time series models. The predictive model 2150 is trained in some embodiments with one or more machine learning approaches including but not limited to supervised learning, unsupervised learning, semi-supervised learning, reinforcement learning, and dimensionality reduction. The predictive model 2150 in some embodiments includes regression analysis including analysis of variance (ANOVA), linear regression, logistic regression, ridge regression, and/or time series. The predictive model 2150 in some embodiments includes classification analysis including decision trees and/or neural networks. In FIG. 21, a depiction of a multi-layer neural network is provided as a non-limiting example of a predictive model 2150, the neural network including an input layer (left side), three hidden layers (middle), and an output layer (right side) with 32 neurons and 192 edges, which is intended to be illustrative, not limiting. The predictive model 2150 is based on data engineering and/or modeling processes. The data engineering processes include exploration, cleaning, normalizing, feature engineering, and scaling. The modeling processes include model selection, training, evaluation, and tuning. The predictive model 2150 is operationalized using registration, deployment, monitoring, and/or retraining processes.

The predictive model 2140 is configured to output results to a device or multiple devices. The device includes means for performing one, more, or all the features referenced herein of the systems, methods, processes, and outputs of one or more of FIGS. 1-20, in any suitable combination. The device is at least one of a server 2155, a tablet 2160, a media display device 2165, a network-connected computer 2170, a media device 2175, a computing device 2180, combinations of the same, or the like.

The predictive model 2150 is configured to output a current state 2181, and/or a future state 2183, and/or a determination, a prediction, or a likelihood 2185, and the like. The current state 2181, and/or the future state 2183, and/or the determination, the prediction, or the likelihood 2185, and the like may be compared 2190 to a predetermined or determined standard. In some embodiments, the standard is satisfied (2190=OK) or rejected (2190=NOT OK). If the standard is satisfied or rejected, the predictive process 2100 outputs at least one of the current state, the future state, the determination, the prediction, the likelihood to any device or module disclosed herein, combinations of the same, or the like. In some embodiments, the predictive model 2150 incorporates one or more LLMs.

### Communication System

A communication system is provided including a computing device, a server, and a communication network. Both the server and the communication network can exist in multiple forms and can connect directly or indirectly. The computing device includes control circuitry, a display, and I/O circuitry. The control circuitry can execute systems, methods, processes, and outputs. Both the computing device and server include control circuitry and storage, which can store content, metadata, data, user profiles, messages, and commands for an application. The computing device communicates with an I/O device and can receive and process user inputs locally or transmit them to the remote server for processing. Both the server and the computing device can transmit and receive content via the communication network or directly, and the processing circuitry receives the user input and converts it to digital signals.

In some embodiments, the system is a distributed network with an edge device (a type of computing device 2202), a cloud server (a type of server 2204), and an internet of things (IoT) network (a type of communication network 2206). Both the edge device and server have microservices and data lakes. The edge device includes a user interface and I/O ports. User interactions can be processed at the edge or in the cloud. The system can transmit and receive digital assets via the IoT network. The edge device communicates with an IoT device and can be various types of smart devices capable of displaying and interacting with digital content. The communication paths in the system can be optimized for latency and bandwidth efficiency.

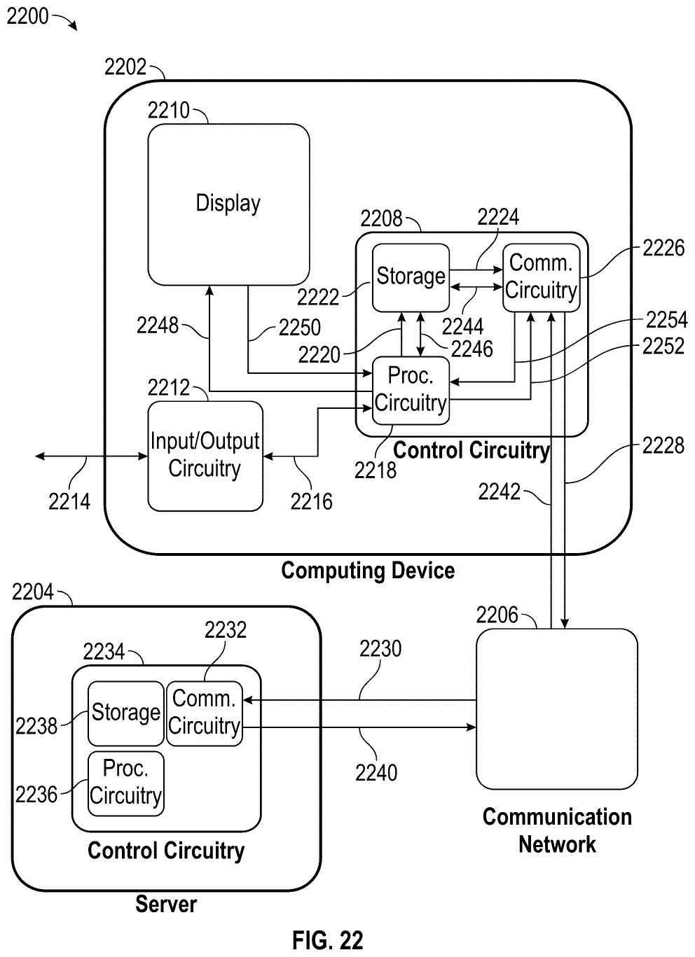

FIG. 22 depicts a block diagram of system 2200, in accordance with some embodiments. The system is shown to include computing device 2202, server 2204, and a communication network 2206. It is understood that while a single instance of a component may be shown and described relative to FIG. 22, additional embodiments of the component may be employed. For example, server 2204 may include, or may be incorporated in, more than one server. Similarly, communication network 2206 may include, or may be incorporated in, more than one communication network. Server 2204 is shown communicatively coupled to computing device 2202 through communication network 2206. While not shown in FIG. 22, server 2204 may be directly communicatively coupled to computing device 2202, for example, in a system absent or bypassing communication network 2206.

Communication network 2206 may include one or more network systems, such as, without limitation, the Internet, LAN, Wi-Fi, wireless, or other network systems suitable for audio processing applications. The system 2200 of FIG. 22 excludes server 2204, and functionality that would otherwise be implemented by server 2204 is instead implemented by other components of the system depicted by FIG. 22, such as one or more components of communication network 2206. In still other embodiments, server 2204 works in conjunction with one or more components of communication network 2206 to implement certain functionality described herein in a distributed or cooperative manner. Similarly, the system depicted by FIG. 22 excludes computing device 2202, and functionality that would otherwise be implemented by computing device 2202 is instead implemented by other components of the system depicted by FIG. 22, such as one or more components of communication network 2206 or server 2204 or a combination of the same. In other embodiments, computing device 2202 works in conjunction with one or more components of communication network 2206 or server 2204 to implement certain functionality described herein in a distributed or cooperative manner.

Computing device 2202 includes control circuitry 2208, display 2210 and input/output (I/O) circuitry 2212. Control circuitry 2208 may be based on any suitable processing circuitry and includes control circuits and memory circuits, which may be disposed on a single integrated circuit or may be discrete components. As referred to herein, processing circuitry should be understood to mean circuitry based on at least one microprocessors, microcontrollers, digital signal processors, programmable logic devices, field-programmable gate arrays (FPGAs), application-specific integrated circuits (ASICs), system-on-chip (SoC), application-specific standard parts (ASSPs), indium phosphide (InP)-based monolithic integration and silicon photonics, non-classical devices, organic semiconductors, compound semiconductors, “More Moore” devices, “More than Moore” devices, cloud-computing devices, combinations of the same, or the like, and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i9 processors) or multiple different processors (e.g., an Intel Core i7 processor and an Intel Core i9 processor). Some control circuits may be implemented in hardware, firmware, or software. Control circuitry 2208 in turn includes communication circuitry 2226, storage 2222 and processing circuitry 2218. Either of control circuitry 2208 and 2234 may be utilized to execute or perform any or all the systems, methods, processes, and outputs of one or more of FIGS. 1-21, or any combination of steps thereof (e.g., as enabled by processing circuitries 2218 and 2236, respectively).

In addition to control circuitry 2208 and 2234, computing device 2202 and server 2204 may each include storage (storage 2222, and storage 2238, respectively). Each of storages 2222 and 2238 may be an electronic storage device. As referred to herein, the phrase “electronic storage device” or “storage device” should be understood to mean any device for storing electronic data, computer software, or firmware, such as random-access memory, read-only memory, cloud-based storage, hard drives, optical drives, digital video disc (DVD) recorders, compact disc (CD) recorders, BLU-RAY disc (BD) recorders, BLU-RAY 3D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each of storage 2222 and 2238 may be used to store several types of content, metadata, and/or other types of data. Non-volatile memory may also be used (e.g., to launch a boot-up routine and other instructions). Cloud-based storage may be used to supplement storages 2222 and 2238 or instead of storages 2222 and 2238. In some embodiments, a user profile and messages corresponding to a chain of communication may be stored in one or more of storages 2222 and 2238. Each of storages 2222 and 2238 may be utilized to store commands, for example, such that when each of processing circuitries 2218 and 2236, respectively, are prompted through control circuitries 2208 and 2234, respectively. Either of processing circuitries 2218 or 2236 may execute any of the systems, methods, processes, and outputs of one or more of FIGS. 1-21, or any combination of steps thereof.

In some embodiments, control circuitry 2208 and/or 2234 executes instructions for an application stored in memory (e.g., storage 2222 and/or storage 2238). Specifically, control circuitry 2208 and/or 2234 may be instructed by the application to perform the functions discussed herein. In some embodiments, any action performed by control circuitry 2208 and/or 2234 may be based on instructions received from the application. For example, the application may be implemented as software or a set of and/or one or more executable instructions that may be stored in storage 2222 and/or 2238 and executed by control circuitry 2208 and/or 2234. The application may be a client/server application where only a client application resides on computing device 2202, and a server application resides on server 2204.

The application may be implemented using any suitable arrangement. For example, it may be a stand-alone application wholly implemented on computing device 2202. In such an approach, instructions for the application are stored locally (e.g., in storage 2222), and data for use by the application is downloaded on a periodic basis (e.g., from an out-of-band feed, from an Internet resource, or using another suitable approach). Control circuitry 2208 may retrieve instructions for the application from storage 2222 and process the instructions to perform the functionality described herein. Based on the processed instructions, control circuitry 2208 may determine a type of action to perform based at least in part on input received from I/O circuitry 2212 or from communication network 2206.

The computing device 2202 is configured to communicate with an I/O device (not shown) via the I/O circuitry 2212. In some embodiments, the user input 2214 is received from the I/O device. A wired and/or wireless connection between the I/O circuitry 2212 and the I/O device is provided in some embodiments. The I/O device may be, for example, at least one of a keyboard, a mouse, a touchscreen, a microphone, a scanner, a joystick, a graphics tablet, a monitor, a printer, speakers, headphones, a projector, a headset, a wearable device, a gaming controller, an external hard drive, a USB hard drive, an SD card, a network interface card (NIC), combinations of the same, or the like.

In client/server-based embodiments, control circuitry 2208 may include communication circuitry suitable for communicating with an application server (e.g., server 2204) or other networks or servers. The instructions for conducting the functionality described herein may be stored on the application server. Communication circuitry may include a cable modem, an Ethernet card, or a wireless modem for communication with other equipment, or any other suitable communication circuitry. Such communication may involve the Internet or any other suitable communication networks or paths (e.g., communication network 2206). In another example of a client/server-based application, control circuitry 2208 runs a web browser that interprets web pages provided by a remote server (e.g., server 2204). For example, the remote server may store the instructions for the application in a storage device.

The remote server may process the stored instructions using circuitry (e.g., control circuitry 2234) and/or generate displays. Computing device 2202 may receive the displays generated by the remote server and may display the content of the displays locally via display 2210. For example, display 2210 may be utilized to present a string of characters. This way, the processing of the instructions is performed remotely (e.g., by server 2204) while the resulting displays, such as the display windows described elsewhere herein, are provided locally on computing device 2204. Computing device 2202 may receive inputs from the user via input/output circuitry 2212 and transmit those inputs to the remote server for processing and generating the corresponding displays.

Alternatively, computing device 2202 may receive inputs from the user via input/output circuitry 2212 and process and display the received inputs locally, by control circuitry 2208 and display 2210, respectively. For example, input/output circuitry 2212 may correspond to a keyboard and/or a set of and/or one or more speakers/microphones which are used to receive user inputs (e.g., input as displayed in a search bar or a display of FIG. 22 on a computing device). Input/output circuitry 2212 may also correspond to a communication link between display 2210 and control circuitry 2208 such that display 2210 updates based at least in part on inputs received via input/output circuitry 2212 (e.g., simultaneously update what is shown in display 2210 based on inputs received by generating corresponding outputs based on instructions stored in memory via a non-transitory, computer-readable medium).

Server 2204 and computing device 2202 may transmit and receive content and data such as media content via communication network 2206. For example, server 2204 may be a media content provider, and computing device 2202 may be a smart television configured to download or stream media content, such as a live news broadcast, from server 2204. Control circuitry 2234, 2208 may send and receive commands, requests, and other suitable data through communication network 2206 using communication circuitry 2232, 2226, respectively. Alternatively, control circuitry 2234, 2208 may communicate directly with each other using communication circuitry 2232, 2226, respectively, avoiding communication network 2206.

It is understood that computing device 2202 is not limited to the embodiments and methods shown and described herein. In nonlimiting examples, computing device 2202 may be a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a handheld computer, a stationary telephone, a personal digital assistant (PDA), a mobile telephone, a portable video player, a portable music player, a portable gaming machine, a smartphone, or any other device, computing equipment, or wireless device, and/or combination of the same, capable of suitably displaying and manipulating media content.

Computing device 2202 receives user input 2214 at input/output circuitry 2212. For example, computing device 2202 may receive a user input such as a user swipe or user touch. It is understood that computing device 2202 is not limited to the embodiments and methods shown and described herein.

User input 2214 may be received from a user selection-capturing interface that is separate from device 2202, such as a remote-control device, trackpad, or any other suitable user movement-sensitive, audio-sensitive or capture devices, or as part of device 2202, such as a touchscreen of display 2210. Transmission of user input 2214 to computing device 2202 may be accomplished using a wired connection, such as an audio cable, USB cable, ethernet cable and the like attached to a corresponding input port at a local device, or may be accomplished using a wireless connection, such as Bluetooth, Wi-Fi, WiMAX, GSM, UTMS, CDMA, TDMA, 8G, 4G, 4G LTE, 5G, NearLink, ultra-wideband technology, or any other suitable wireless transmission protocol. Input/output circuitry 2212 may include a physical input port such as a 12.5 mm (0.4921 inch) audio jack, RCA audio jack, USB port, ethernet port, or any other suitable connection for receiving audio over a wired connection or may include a wireless receiver configured to receive data via Bluetooth, Wi-Fi, WiMAX, GSM, UTMS, CDMA, TDMA, 3G, 4G, 4G LTE, 5G, NearLink, ultra-wideband technology, or other wireless transmission protocols.

Processing circuitry 2218 may receive user input 2214 from input/output circuitry 2212 using communication path 2216. Processing circuitry 2218 may convert or translate the received user input 2214 that may be in the form of audio data, visual data, gestures, or movement to digital signals. In some embodiments, input/output circuitry 2212 performs the translation to digital signals. In some embodiments, processing circuitry 2218 (or processing circuitry 2236, as the case may be) conducts disclosed processes and methods.

Processing circuitry 2218 may provide requests to storage 2222 by communication path 2220. Storage 2222 may provide requested information to processing circuitry 2218 by communication path 2246. Storage 2222 may transfer a request for information to communication circuitry 2226 which may translate or encode the request for information to a format receivable by communication network 2206 before transferring the request for information by communication path 2228. Communication network 2206 may forward the translated or encoded request for information to communication circuitry 2232, by communication path 2230.

At communication circuitry 2232, the translated or encoded request for information, received through communication path 2230, is translated or decoded for processing circuitry 2236, which will provide a response to the request for information based on information available through control circuitry 2234 or storage 2238, or a combination thereof. The response to the request for information is then provided back to communication network 2206 by communication path 2240 in an encoded or translated format such that communication network 2206 forwards the encoded or translated response back to communication circuitry 2226 by communication path 2242.

At communication circuitry 2226, the encoded or translated response to the request for information may be provided directly back to processing circuitry 2218 by communication path 2254 or may be provided to storage 2222 through communication path 2244, which then provides the information to processing circuitry 2218 by communication path 2246. Processing circuitry 2218 may also provide a request for information directly to communication circuitry 2226 through communication path 2252, where storage 2222 responds to an information request (provided through communication path 2220 or 2244) by communication path 2224 or 2246 that storage 2222 does not contain information pertaining to the request from processing circuitry 2218.

Processing circuitry 2218 may process the response to the request received through communication paths 2246 or 2254 and may provide instructions to display 2210 for a notification to be provided to the users through communication path 2248. Display 2210 may incorporate a timer for providing the notification or may rely on inputs through input/output circuitry 2212 from the user, which are forwarded through processing circuitry 2218 through communication path 2248, to determine how long or in what format to provide the notification. When display 2210 determines the display has been completed, a notification may be provided to processing circuitry 2218 through communication path 2250.

The communication paths provided in FIG. 22 between computing device 2202, server 2204, communication network 2206, and all subcomponents depicted are examples and may be modified to reduce processing time or enhance processing capabilities for each step in the processes disclosed herein by one skilled in the art.

### Terminology

The terminology used herein is for the purpose of describing particular embodiments only and is not intended to be limiting of the disclosure.

Throughout the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises.”

Throughout the specification the phrases “in response to” and “based on” shall be understood to have a broad meaning unless context requires otherwise. For example, “in response to” can refer to a step that is in direct or indirect response to a prior step, and “based on”can refer to a step that is based at least in part on a prior step.

As used herein, the terms “real time,” “simultaneous,” “substantially on-demand,” and the like are understood to be nearly instantaneous but may include delay due to practical limits of the system. Such delays may be in the order of milliseconds or microseconds, depending on the application and nature of the processing. Relatively longer delays (e.g., greater than a millisecond) may result due to communication or processing delays, particularly in remote and cloud computing environments.

As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Although at least some embodiments are described as using a plurality of units or modules to perform a process or processes, it is understood that the process or processes may also be performed by one or a plurality of units or modules. Additionally, it is understood that the term controller/control unit may refer to a hardware device that includes a memory and a processor. The memory may be configured to store the units or the modules, and the processor may be specifically configured to execute said units or modules to perform one or more processes which are described herein.

Unless specifically stated or obvious from context, as used herein, the term “about” is understood as within a range of normal tolerance in the art, for example within 2 standard deviations of the mean. “About” may be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The use of the terms “first”, “second”, “third”, and so on, herein, are provided to identify structures or operations, without describing an order of structures or operations, and, to the extent the structures or operations are used in an embodiment, the structures may be provided or the operations may be executed in a different order from the stated order unless a specific order is definitely specified in the context.

The methods and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory (e.g., a non-transitory, computer-readable medium accessible by an application via control or processing circuitry from storage) including, but not limited to, volatile and non-volatile computer memory or storage devices such as a hard disk, floppy disk, USB drive, DVD, CD, media cards, register memory, processor caches, random access memory (RAM), UltraRAM, cloud-based storage, and the like.

The interfaces, processes, and analysis described may, in some embodiments, be performed by an application. The application may be loaded directly onto each device of any of the systems described or may be stored in a remote server or any memory and processing circuitry accessible to each device in the system. The generation of interfaces and analysis there-behind may be performed at a receiving device, a sending device, or some device or processor therebetween.

Any use of a phrase such as “in some embodiments” or the like with reference to a feature is not intended to link the feature to another feature described using the same or a similar phrase. Any and all embodiments disclosed herein are combinable or separately practiced as appropriate. Absence of the phrase “in some embodiments” does not infer that the feature is necessary. Inclusion of the phrase “in some embodiments” does not infer that the feature is not applicable to other embodiments or even all embodiments.

The systems and processes discussed herein are intended to be illustrative and not limiting. One skilled in the art would appreciate that the actions of the processes discussed herein may be omitted, modified, combined, duplicated, rearranged, and/or substituted, and any additional actions may be performed without departing from the scope of the invention. More generally, the disclosure herein is meant to provide examples and is not limiting. Only the claims that follow are meant to set bounds as to what the present disclosure includes. Furthermore, it should be noted that the features and limitations described in any some embodiments may be applied to any other embodiment herein, and flowcharts or examples relating to some embodiments may be combined with any other embodiment in a suitable manner, done in different orders, or done in parallel. In addition, the methods and systems described herein may be performed in real time. It should also be noted that the methods and/or systems described herein may be applied to, or used in accordance with, other methods and/or systems.

This description is to be taken only by way of example and not to otherwise limit the scope of the embodiments herein. Therefore, it is the object of the appended claims to cover all such variations and modifications as come within the true spirit and scope of the embodiments herein.

1. A method of controlling a megapixel projector of a vehicle including a sensor, the method comprising:
causing to output an environmental scan of the vehicle based at least in part on sensor data from the sensor of the vehicle for processing at a web service;
receiving from the web service an image data structure comprising image metadata based at least in part on the environmental scan;
receiving a megapixel projector control data structure comprising megapixel projection control instructions, based at least in part on the environmental scan;
causing image metadata based at least in part on the image data structure to be sent to a megapixel projector controller;
causing megapixel projector control instructions, based at least in part on the megapixel projector control data structure, to be sent to the megapixel projector controller;
monitoring a condition of a driver in the vehicle, wherein the condition comprises drowsiness; and
based at least in part on the monitored condition of the driver of the vehicle, causing to generate an image by the megapixel projector based at least in part on the image metadata and the megapixel projector control instructions.

2. The method of claim 1, comprising:
sending and receiving information to and from an application accessed via a mobile communication device; and
causing to generate for display, at the mobile communication device, a user-selectable option for controlling the image to be generated by the megapixel projector.

3. The method of claim 2, wherein the causing to generate for display, at the mobile communication device, the user-selectable option for controlling the image to be generated by the megapixel projector includes at least one of an option for associating the image with a location of the vehicle, an option to display the image to be generated by the megapixel projector, or an option to display the image to be generated by the megapixel projector in an environment where the image is to be displayed.

4. The method of claim 1, comprising:
determining a local condition at or near the vehicle based at least in part on the environmental scan; and
adjusting the image based at least in part on the local condition.

5. (canceled)

6. The method of claim 1, wherein the condition further comprises at least one of fatigue, distraction, an irregular driving pattern, frequent lane changes, excessive speed, or following too closely another vehicle.

7. The method of claim 1, wherein the environmental scan includes an illumination condition around the vehicle, the method comprising:
determining an optimal location for projection of the image based at least in part on the illumination condition around the vehicle, wherein the control instructions include information corresponding to the optimal location for projection of the image.

8. The method of claim 1, comprising:
determining a location of the vehicle;
sending the location of the vehicle to a web service; and
receiving, from the web service, an environmental condition associated with the location of the vehicle, wherein the image is generated based at least in part on the environmental condition associated with the location of the vehicle.

9. The method of claim 8, wherein the environmental condition includes a weather condition.

10. The method of claim 1, wherein the image is an image for verifying a ride service, the method comprising:
receiving a signal from a mobile communication device associated with a device of a rider utilizing the ride service, wherein the signal includes information verifying capture, by the mobile communication device associated with the device of the rider, of the image for verifying the ride service; and
based at least in part on receiving the signal from the mobile communication device associated with the device of the rider verifying the capture of the image for verifying the ride service, causing the vehicle to perform an action.

11-30. (canceled)

31. A system for controlling a megapixel projector of a vehicle, the system comprising:
a sensor configured to output an environmental scan of the vehicle;
a web service configured to receive the environmental scan and generate an image data structure comprising image metadata and a megapixel projector control data structure comprising megapixel projection control instructions, based at least in part on the environmental scan;
a megapixel projector controller configured to receive image metadata based on the image data structure and megapixel projector control instructions based on the megapixel projector control data structure; and
a megapixel projector configured to generate an image based at least in part on: (a) a monitored condition of the driver of the vehicle, wherein the monitored condition comprises drowsiness, (b) the image metadata, and (c) the megapixel projector control instructions.

32. The system of claim 31, further comprising:
a mobile communication device configured to send and receive information to and from an application; and
a display configured to present a user-selectable option for controlling the image to be generated by the megapixel projector.

33. The system of claim 32, wherein the display is configured to present at least one of an option for associating the image with a location of the vehicle, an option to display the image to be generated by the megapixel projector, or an option to display the image to be generated by the megapixel projector in an environment where the image is to be displayed.

34. The system of claim 31, further comprising:
a local condition detector configured to determine a local condition at or near the vehicle based on the environmental scan; and
an image adjuster configured to adjust the image based on the local condition.

35. (canceled)

36. The system of claim 31, wherein the monitored condition further comprises at least one of fatigue, distraction, an irregular driving pattern, frequent lane changes, excessive speed, or following too closely another vehicle.

37. The system of claim 31, wherein the environmental scan includes an illumination condition around the vehicle, the system further comprising:
an optimal location determiner configured to determine an optimal location for projection of the image based on the illumination condition around the vehicle, wherein the control instructions include information corresponding to the optimal location for projection of the image.

38. The system of claim 31, further comprising:
a location determiner configured to determine a location of the vehicle;
a web service configured to receive the location of the vehicle and provide an environmental condition associated with the location of the vehicle, wherein the image is generated based on the environmental condition associated with the location of the vehicle.

39. The system of claim 38, wherein the environmental condition includes a weather condition.

40. The system of claim 31, wherein the image is an image for verifying a ride service, the system further comprising:
a signal receiver configured to receive a signal from a mobile communication device associated with a device of a rider utilizing the ride service, wherein the signal includes information verifying capture, by the mobile communication device associated with the device of the rider, of the image for verifying the ride service; and
a vehicle action controller configured to cause the vehicle to perform an action based on receiving the signal from the mobile communication device associated with the device of the rider verifying the capture of the image for verifying the ride service.

41-150. (canceled)

151. The method of claim 1, wherein the monitoring the condition of the driver of the vehicle comprises using facial expression recognition to detect signs of drowsiness, fatigue, or distraction of the driver.

152. The method of claim 31, wherein the monitored condition of the driver of the vehicle is detected using facial expression recognition.
